(19) United States
(12) Patent Application Publication
(10) Pub. No.: US 2025/0088267 A1
(43) Pub. Date: Mar. 13, 2025

(54) INDOOR OPTICAL WIRELESS COMMUNICATIONS-ORIENTED GENERAL GEOMETRY-BASED STOCHASTIC CHANNEL MODELING METHOD

(71) Applicants: Southeast University, Nanjing (CN); PURPLE MOUNTAIN LABORATORIES, Nanjing (CN)

(72) Inventors: Chengxiang WANG, Nanjing (CN); Xiuming ZHU, Nanjing (CN); Jun WANG, Nanjing (CN); Rui FENG, Nanjing (CN); Jie HUANG, Nanjing (CN)

(21) Appl. No.: 18/813,519

(22) Filed: Aug. 23, 2024

(30) Foreign Application Priority Data
Aug. 28, 2023 (CN) 202311097441.3

(51) Int. Cl. H04B 10/073; H04B 10/114; H04B 10/50; H04B 17/391

(52) U.S. Cl. CPC H04B 10/073; H04B 10/114; H04B 10/502; H04B 17/391

(57) ABSTRACT

The present application discloses an indoor optical wireless communications-oriented general geometry-based stochastic channel modeling method, which belongs to the field of wireless communication channel modeling. The method includes: setting scenario layout and frequency band related parameters; generating an object reflection cluster birth-death process matrix and random numbers for controlling a blocking effect and propagation component classification; initializing a scattering cluster and intra-cluster scatterers; updating and calculating model parameters varying with space and time; calculating a light source radiation intensity, the power distributions of object reflection and particle scattering, and an equivalent reflection coefficient; and calculating a subchannel impulse response, and determining whether a propagation component exists, to generate a final channel impulse response. The general geometry-based stochastic channel modeling method for indoor optical wireless communications of the present invention can utilize the common characteristics of the wireless frequency bands of light and the unique characteristics of the frequency bands of infrared light, visible light and ultraviolet light. By setting corresponding parameters, the established model can support different frequency bands to be flexibly applied to the simulation and performance evaluation of 6G indoor optical wireless communication systems.

### FIELD OF THE INVENTION

The present application belongs to the technical field of wireless communication channel modeling, and in particular, relates to an indoor optical wireless communications-oriented general geometry-based stochastic channel modeling method.

### DESCRIPTION OF RELATED ART

With the popularization of smart terminals and the rapid development of the information age, the requirements for communication services are constantly increasing. Wireless communications have evolved from the first generation (1G) to the fifth generation (5G), with higher frequency bands being used, bandwidth increasing, and peak rates growing rapidly. In response to the growing demand for data traffic and number of connections, and in order to alleviate the crisis of saturation of radio frequency spectrum, optical wireless communications have attracted widespread attention due to their unlicensed ultra-wide spectrum, high data security, low cost, low power consumption, and resistance to electromagnetic interference. The optical wireless band includes infrared light, visible light and ultraviolet light, with a wavelength range of approximately 200 nm to 3,000 nm and a frequency range of approximately 100 THz to 1,500 THz. The application scenarios include indoor high-speed data communications, outdoor vehicle-to-vehicle communications, underwater, air, etc. Compared with traditional RF frequency bands, optical wireless communication channels have propagation characteristics such as no small-scale fading, negligible Doppler, great impact of the directionality of the transmitter (Tx) and receiver (Rx), susceptibility to obstruction, atmospheric absorption and wavelength dependence of scattering, diffuse reflection and reflection coefficients, which brings challenges to the design, analysis and application of optical wireless communication systems. Analysis and modeling of the characteristics of optical wireless communication channels are the basis of system design, performance evaluation, optimization and deployment.

At present, infrared and visible light communications are widely used in indoor scenarios, but some recent studies attempt to employ ultraviolet light for communications in indoor scenarios. The research on optical wireless communication channel modeling in typical indoor scenarios has attracted the attention of many researchers. Lots of indoor optical wireless channel models have been proposed, which can be divided into deterministic channel models and stochastic channel models. Typical highly accurate deterministic optical wireless channel models include recursive channel models, Zemax-based ray tracing models, and single scattering theory models. However, these models have high computational complexity and lack generality. Stochastic channel models include geometry-based stochastic models (GBSM) and non-geometric stochastic channel models. Among them, GBSM abstracts the environment as a scatterer, and can obtain channel information based on simple ray tracing. This method is extensively applicable and has been adopted by multiple 5G standardized channel models.

In the era of the sixth generation (6G) wireless communications, various communication technologies will continue to develop and show a trend of integration. Proposing a general channel model using a unified framework will help promote the standardization of 6G channel models and the research on 6G communication systems. It is worth noting that the existing optical wireless communication channel models mostly focus on a single frequency band, and a few general models only support outdoor non-line-of-sight scattering communication scenarios and cannot be used in indoor scenarios. So far, no general channel model for indoor scenarios supporting all optical bands has been proposed.

### SUMMARY OF THE INVENTION

The present application provides an indoor optical wireless communications-oriented general geometry-based stochastic channel modeling method. With typical indoor communication scenarios taken into account, the method integrates the common propagation characteristics of optical wireless communication frequency bands with the unique propagation characteristics of infrared light, visible light, and ultraviolet light, and proposes a three-dimensional general geometry-based stochastic channel model for indoor optical wireless communications, providing a research basis for the design and development of 6G optical wireless communication systems.

The embodiments of the present application provide an indoor optical wireless communications-oriented general geometry-based stochastic channel modeling method, comprising the following steps:
Step S1: establishing an indoor optical wireless communication channel simulation scenario, and setting simulation scenario layout and frequency band parameters;
Step S2: generating an object reflection cluster birth-death process matrix of a transmit array, a random number matrix for controlling whether a direct component exists, and a random number matrix for propagation component classification;
Step S3: initializing an object reflection cluster, a particle scattering cluster and intra-cluster scatterers;
Step S4: updating and calculating model parameters varying with space and time;
Step S5: calculating a light source radiation intensity, an object reflection power distribution, a particle scattering power distribution, and a wavelength range-related equivalent reflection coefficient; and
Step S6: calculating an impulse response of each subchannel, and determining whether a direct component of the subchannel exists and whether an indirect component of object reflection exists, to obtain a final channel impulse response.

In an embodiment of the present application, the step S1 further includes:
Step S101: establishing an indoor optical wireless communication channel simulation scenario, wherein the indoor optical wireless communication channel simulation scenario comprises an LED array serving as a transmitter, and a photoelectric detector serving as receiver, and a global coordinate system is established by defining a ray from the first-row and first-column LED cell at the transmitter to the receiver as an x axis, and taking a plane perpendicular to the same as a yoz plane;
Step S102: setting physical environment parameters of the simulation scenario layout, comprising transmitting-end parameters, receiving-end parameters, distance parameters and blocking effect parameters; and
Step S103: setting frequency band parameters, comprising a proportion η_{SB} of single-cluster propagation, a probability p_{particle} of a propagation component being scattered by particles in the environment, a proportion αₙ of diffuse reflection of a light signal on a material in the environment, a spread parameter σ^{RE} of the object reflection cluster, a spread parameter σ^{PS} of the particle scattering cluster, a particle extinction coefficient kₑ, a particle Rayleigh scattering coefficient kₛᵣ, and a particle Mie scattering coefficient kₛₘ.

In an embodiment of the present application, the step S102 further includes:
Step S1021: setting the transmitting-end parameters, comprising direction parameters of the LED array, a number M_{I} and a cell spacing δ_{H}^{T} of the LED cells of the LED array in the horizontal direction, and a number M_{J} and a cell spacing δ_{V}^{T} of the LED cells of the LED array in the vertical direction, wherein the direction parameters of the LED array comprise an azimuth angle β_{H,A}^{T} and an elevation angle β_{V,E}^{T} of the LED array in the horizontal direction, and an azimuth angle β_{V,A}^{T} and an elevation angle β_{V,E}^{T} of the LED array in the vertical direction;
Step S1022: setting the receiving-end parameters, comprising an azimuth angle β_{A}^{R} and an elevation angle β_{E}^{R} of the normal of the receiver, an area A_{R} of the receiver, a viewing angle Ψ_{FoV} at the receiver, a translational azimuth angle α_{A}^{R}(t) and an elevation angle α_{E}^{R}(t) as well as a velocity v^{R}(t) of the receiver, and a rotational azimuth angular velocity ω_{A}^{R}(t) and an elevation angular velocity ω_{E}^{R}(t) of the receiver;
Step S1023: setting the distance parameters, comprising a distance D₁₁ from the first-row and first-column LED cell L₁₁ of the LED array to the receiver;
Step S1024: setting the blocking effect parameters, comprising a probability p_{blockage} of a line-of-sight component being blocked.

In an embodiment of the present application, the step S2 further includes:
Step S201: generating an object reflection cluster birth-death process matrix of a transmitting-end array, specifically comprising:
Step S2011: calculating a number N_{c0} of the clusters seen by the LED cell L₁₁ at the initial moment, expressed as:

$${N}_{c 0} = \frac{{λ}_{B}}{{λ}_{D}}$$

where, λ_{B} and λ_{D} are the birth and death rates of the clusters, respectively;
Step S2012: generating a visibility matrix of the first-column LED cells L₁₁-L_{M}_{_{I}}₁ for the clusters based on the LED cell L₁₁, wherein column evolution is performed in the horizontal direction, and a survival probability of the clusters in a spacing of δ_{H}^{T} is:

$${P}_{H , remain} ( {δ}_{H}^{T} ) = exp ( - {λ}_{B} \cdot \frac{{δ}_{H}^{T} cos ( {β}_{H , E}^{T} )}{{D}_{c}^{A}} )$$

where, D_{c}^{A} is an array-related factor associated with a specific scenario;
the number of the newly generated clusters follows a Poisson distribution, with a mean of:

$$𝔼 ( {N}_{N e w , H} ) = \frac{{λ}_{B}}{{λ}_{D}} [ 1 - {P}_{H , r emain} ( {δ}_{H}^{T} ) ]$$

Step S2013: generating a visibility matrix of the LED cells in each column for the clusters based on the first-column LED cells L₁₁-L_{M}_{_{I}}₁ generated in Step S2012, wherein column evolution is performed in the vertical direction, and a survival probability of the clusters in a spacing of δ_{V}^{T} is:

$${P}_{V , remain} ( {δ}_{V}^{T} ) = exp ( - {λ}_{B} \cdot \frac{{δ}_{V}^{T} cos ( {β}_{V , E}^{T} )}{{D}_{c}^{A}} )$$

the number of the newly generated clusters follows a Poisson distribution, with a mean of:

$$𝔼 ( {N}_{N e w , V} ) = \frac{{λ}_{B}}{{λ}_{D}} [ 1 - {P}_{V , r e m a i n} ( {δ}_{V}^{T} ) ]$$

Step S2014: generating a final object reflection cluster birth-death process matrix of a transmitting-end array, namely, a matrix with dimensions of M_{I}×M_{J}×N_{c,total}, wherein the total number N_{c,total} of the object reflection clusters is equal to the sum of N_{c0} and the number of the newly generated clusters; and
Step S202: calculating an existence probability p_{LoS}=(1−p_{blockage})·(1−p_{particle}) of a direct component, and generating a 0/1 random number matrix for controlling whether the direct component exists according to the existence probability of the direct component, with dimensions of M_{I}×M_{J}; and generating Mₙ 0/1 random numbers according to p_{particle}, and classifying a propagation component according to whether the propagation component after object reflection further undergoes scattering before reaching the receiver, wherein Mₙ is the number of scatterers in the object reflection cluster.

In an embodiment of the present application, the step S3 further includes:
Step S301: stochastically generating a position of the object reflection cluster at the initial moment, the initial position of the cluster determined by azimuth angle, elevation angle and distance parameters, specifically comprising:
Step S3011: stochastically generating the angle parameters of N_{c,total} object reflection clusters, modeling the same to follow a wrapped Gaussian distribution, and generating the angle parameters of N_{c,total}×(1−η_{SB}) object reflection clusters at the receiver; and
Step S3012: stochastically generating distances dₙ^{T} and dₙ^{R} from the object reflection cluster to the LED unit L₁₁ at the initial moment, wherein a non-negative exponential distribution is followed;
Step S302: calculating an equivalent normal direction and an equivalent mirror reflection direction of each object reflection cluster according to a geometric relationship. In the case of single object reflection, an equivalent normal points from the cluster center to a ray from L₁₁ to the receiver, and is perpendicular to the ray, an equivalent mirror reflection direction vector is in the same plane as the cluster center, L₁₁ and the receiver, and an angle formed with the equivalent normal is equal to an angle between a vector from the cluster center to L₁₁ and the equivalent normal. In the case of double object reflection, an equivalent normal of a transmitting-end cluster points from the cluster center to a ray from L₁₁ to a receiver cluster and is perpendicular to the ray, an equivalent mirror reflection direction vector thereof is in the same plane as the cluster center, L₁₁ and the receiving-end cluster, and an angle formed with the equivalent normal is equal to an angle between a vector from the cluster center to L₁₁ and the equivalent normal, an equivalent normal of the receiver cluster points from the cluster center to a ray from the transmitter cluster to the receiver and is perpendicular to the ray, an equivalent mirror reflection direction vector thereof is in the same plane as the cluster center, the transmitting-end cluster and receiver, and an angle formed with the equivalent normal is equal to an angle between a vector from the cluster center to the transmitting-end cluster and the equivalent normal;
Step S303: generating a particle scattering cluster representing a particle scattering effect of an ultraviolet light signal at the receiver, wherein a ray from the receiver to the center of the particle scattering cluster is kept consistent with the normal direction of the receiver in azimuth angle and elevation angle, and a distance from the center of the particle scattering cluster to the receiver is set to a constant; and
Step S304: stochastically generating the coordinates of each intra-cluster scatterer in the global coordinate system, specifically comprising:
Step S3041: stochastically generating the coordinates [x′, y′, z′]^{T} of each intra-cluster scatterer in a local coordinate system with the cluster center as the origin, following a three-dimensional elliptical Gaussian distribution, expressed as:

$$p ( {x}^{′} , {y}^{′} , {z}^{′} ) = \frac{exp ( - \frac{{x}^{′2}}{2 {σ}_{DS}^{2}} - \frac{{y}^{′2}}{2 {σ}_{AS}^{2}} - \frac{{z}^{′2}}{2 {σ}_{B S}^{2}} )}{{( 2 π )}^{\frac{3}{2}} {σ}_{D S} {σ}_{AS} {σ}_{E S}}$$

where, σ_{DS} and σ_{AS}, σ_{ES} represent intra-cluster delay spread, angular spread and elevation spread respectively, and different cluster spread parameters are substituted for the generation of the object reflection cluster and the particle scattering cluster; and
Step S3042: obtaining the coordinates [x, y, z]^{T} of each scatterer in the global coordinate system through coordinate transformation, expressed as:

$$[ \begin{matrix}x \\ y \\ z\end{matrix} ] = [ \begin{matrix}cos ( {\overline{ϕ}}_{A} ) & - sin ( {\overline{ϕ}}_{A} ) & 0 \\ sin ( {\overline{ϕ}}_{A} ) & cos ( {\overline{ϕ}}_{A} ) & 0 \\ 0 & 0 & 1\end{matrix} ] [ \begin{matrix}cos ( {\overline{ϕ}}_{E} ) & 0 & - sin ( {\overline{ϕ}}_{E} ) \\ 0 & 1 & 0 \\ sin ( {\overline{ϕ}}_{E} ) & 0 & cos ( {\overline{ϕ}}_{E} )\end{matrix} ] [ \begin{matrix}{x}^{′} + \overline{d} \\ {y}^{′} \\ {z}^{′}\end{matrix} ]$$

where, d̅, ϕ̅_{A} and ϕ̅_{E} represent an average distance, an azimuth angle and an elevation angle of a cluster respectively.

In an embodiment of the present application, the step S4 further includes:
Step S401: updating the coordinates of the scatterers and the receiver in the global coordinate system at each moment, and calculating the coordinates Lᵢⱼ of in the global coordinate system according to a geometric relationship and the set movement velocity of the object reflection cluster, and the movement and rotation velocity of the receiver;
Step S402: updating and calculating the angle parameters of each propagation ray in the local coordinate system of each LED cell, specifically comprising:
Step S4021: establishing a local coordinate system of an LED cell Lᵢⱼ, with the cell Lᵢⱼ in the ith row and jth column of the LED array as an origin, the normal direction of the LED array as an x′ᵢⱼ axis, the vertical direction of the LED array as a y′ᵢⱼ axis, and the horizontal direction of the LED array as a z′ᵢⱼ axis; and
Step S4022: performing a rotation transformation first on the Cartesian coordinates of each scatterer in the global coordinate system obtained in Step S3042 to obtain the Cartesian coordinates of the local coordinate system of the LED cell L₁₁, then, performing a translation transformation to obtain the Cartesian coordinates of the local coordinate system of the LED cell Lᵢⱼ, and at last, transforming the Cartesian coordinates of the local coordinate system of the LED cell Lᵢⱼ into spherical coordinates, to obtain an elevation angle of departure and an azimuth angle of departure of each propagation ray in the local coordinate system of the LED cell Lᵢⱼ, comprising an elevation angle of departure \tilde{ψ}_{ij,E,L}^{T}(t) and an azimuth angle of departure \tilde{ψ}_{ij,A,L}^{T}(t) of a direct path in the Lᵢⱼ local coordinate system, an elevation angle of departure \tilde{ω}_{ij,E,q}^{T}(t) and an azimuth angle of departure \tilde{ψ}_{ij,A,q}^{T}(t) of a ray from Lᵢⱼ to the qth scatterer in the particle scattering cluster in the Lᵢⱼ local coordinate system, and an elevation angle of departure \tilde{ω}_{ij,E,m}_{₁₍₂₎ₙ}^{T}(t) and an azimuth angle of departure \tilde{ω}_{ij,A,m}_{₁₍₂₎ₙ}^{T}(t) of a ray from Lᵢⱼ to the m₁ (m₂)th scatterer in the nth object reflection cluster at the transmitter in the Lᵢⱼ local coordinate system;
Step S403: updating and calculating the angle parameters of each propagation ray according to the global coordinates of each scatterer and the receiver updated in Step S401, specifically comprising:
Step S4031: determining whether a ray in a single object reflection cluster reaches the receiver simply by a single reflection according to the 0/1 random numbers for propagation component classification generated in Step S202;
Step S4032: obtaining normalized transmission vectors according to a coordinate method, comprising a normalized direction vector r_{ij,L}^{T}(t) from Lᵢⱼ to the receiver, a normalized direction vector r_{ij,q}^{T}(t)(t) from Lᵢⱼ to the qth scatterer in the particle scattering cluster, a normalized direction vector r_{q}^{R}(t) from the qth scatterer in the particle scattering cluster to the receiver, a normalized direction vector r_{ij,m}_{₁₍₂₎ₙ}^{T}(t) from Lᵢⱼ to the m₁ (m₂)th scatterer in the nth object reflection cluster at the transmitter, a normalized direction vector rₘ_{₁₍₂₎ₙ}^{T}(t)(t) from the m₁ (m₂)th scatterer in the nth object reflection cluster at the transmitter to the receiver, a normalized direction vector rₘ_{₁ₙ}^{RE-RE}(t) from the m₁th scatterer in the nth object reflection cluster at the transmitter to the m₁th scatterer in the nth object reflection cluster at the receiver, and a normalized direction vector rₘ_{_{2n,q}}^{RE-PS}(t) from the m₂th scatterer in the nth object reflection cluster at the transmitter to the qth scatterer in the particle scattering cluster; and
Step S4033: updating and calculating the angle parameters of each propagation component according to the cosine law, comprising an angle ψ_{ij,L}^{R}(t) between −r_{ij,L}^{T}(t) and the normal direction of the receiver, an angle θ_{ij,q}^{PS}(t) between r_{ij,q}^{T}(t) and r_{q}^{R}(t), an angle ψ_{q}^{R}(t) between −r_{q}^{R}(t) and the normal direction of the receiver, an angle ψ_{ij,m}_{₁₍₂₎ₙ}^{S,T}(t) between −r_{ij,m}_{₁₍₂₎ₙ}^{T}(t) and the equivalent normal direction of, the nth object reflection cluster at the transmitter, angles ψₘ_{₁ₙ}^{S,R,1}(t) and ψₘ_{₁ₙ}^{S,R,2}(t) between rₘ_{₁ₙ}^{R}(t) and the equivalent normal direction and equivalent mirror reflection direction of the nth object reflection cluster at the transmitter, an angle ψₘ_{₁ₙ}^{R}(t) between rₘ_{₁ₙ}^{R}(t) and the normal direction of the receiver, angles ψₘ_{_{2n,q}}^{S,R,1}(t) and ψₘ_{_{2n,q}}^{S,R,2}(t) between rₘ_{_{2n,q}}^{RE-PS}(t) and the equivalent normal direction and equivalent mirror reflection direction of the nth object reflection cluster at the transmitter, and an angle θₘ_{_{2n,q}}^{PS}(t) between rₘ_{_{2n,q}}^{RE-PS}(t) and r_{q}^{R}(t); and
Step S404: updating and calculating the propagation distance parameters of each propagation ray at each moment according to the global coordinates of the scatterers, Lᵢⱼ and the receiver updated in Step S401 and a coordinate method, comprising a distance Dᵢⱼ(t) from Lᵢⱼ to the receiver, a distance d_{ij,q}^{T}(t) from Lᵢⱼ to the qth scatterer in the particle scattering cluster, a distance d_{q}^{R}(t) from the qth scatterer in the particle scattering cluster to the receiver, a distance d_{ij,m}_{₁₍₂₎ₙ}^{T}(t) from Lᵢⱼ to the m₁ (m₂)th scatterer in the nth object reflection cluster at the transmitter, a distance dₘ_{₁₍₂₎ₙ}^{R}(t) from the m₁ (m₂)th scatterer in the nth object reflection cluster at the transmitter to the receiver, a distance dₘ_{₁ₙ}^{RE-RE}(t) from the m₁th scatterer in the nth object reflection cluster at the transmitter to the m₁th scatterer in the n object reflection cluster at the receiver, and a distance dₘ_{_{2n,q}}^{RE-PS}(t) from the m₂th scatterer in the nth object reflection cluster at the transmitter to the qth scatterer in the particle scattering cluster.

In an embodiment of the present application, the step S5 further includes:
Step S501: calculating a light source radiation intensity in a direction corresponding to the propagation ray, expressed as:

$${F}_{i j} ( {\tilde{ψ}}_{ij , E}^{{}_{{}_{T}}} , {\tilde{ψ}}_{ij , A}^{{}_{{}_{T}}} ) = \frac{α + 1}{2 π} {cos}^{α} ( {\tilde{ψ}}_{ij , E}^{{}_{{}_{T}}} ) {cos}^{α} ( {\tilde{ψ}}_{ij , A}^{{}_{{}_{T}}} )$$

where, α is a mode number of a Lambertian radiation mode; and the angle parameters obtained in Step S4022 are substituted in the equation above to calculate a light source radiation intensity corresponding to each propagation component;
Step S502: calculating a power distribution of the propagation ray after object reflection according to a Phong's reflection model, expressed as:

$${R}_{n} ( {ψ}_{n}^{S , R , 1} ( t ) , {ψ}_{n}^{S , R , 2} ( t ) ) = {α}_{n} \frac{cos ( {ψ}_{n}^{S , R , 1} ( t ) )}{π} + ( 1 - {α}_{n} ) \frac{{m}_{s n} + 1}{2 π} {cos}^{{m}_{s n}} ( {ψ}_{n}^{S , R , 2} ( t ) )$$

where, mₛₙ is a directional parameter of a mirror reflection component; and the angle parameters between the propagation ray and the equivalent normal direction and equivalent mirror reflection direction of the object reflection cluster obtained in Step S4033 are substituted in the equation above, to calculate the radiation powers of the propagation components after object reflection within a unit solid angle in the propagation direction;
Step S503: calculating a power distribution of the propagation ray after particle scattering according to a particle scattering phase function, expressed as:

$$P ( {θ}^{P S} ) = \frac{{k}_{s , r}}{{k}_{s}} {P}_{r} ( {θ}^{P S} ) + \frac{{k}_{s , m}}{{k}_{s}} {P}_{m} ( {θ}^{P S} )$$

where, kₛ is a scattering coefficient, equal to the sum of a particle Rayleigh scattering coefficient kₛᵣ and a particle Mie scattering coefficient kₛₘ, and Pᵣ(θ^{PS}) and Pₘ(θ^{PS}) are a Rayleigh scattering phase function and a Mie scattering phase function respectively, wherein Pᵣ(θ^{PS}) is expressed as:

$${P}_{r} ( {θ}^{P S} ) = \frac{3 [ 1 + 3 γ + ( 1 - γ ) {cos}^{2} {θ}^{P S} ]}{16 π ( 1 + 2 γ )}$$

where, γ is a Rayleigh scattering model parameter, determined by a depolarization factor;
Pₘ(θ^{PS}) is expressed as:

$${P}_{m} ( {θ}^{P S} ) = \frac{1 - {g}^{2}}{4 π} [ \frac{1}{{( 1 + {g}^{{}_{2}} - 2 g cos {θ}^{P S} )}^{3 / 2}} + \frac{f ( 3 {cos}^{2} {θ}^{P S} - 1 )}{2 {( 1 + {g}^{{}_{2}} )}^{3 / 2}} ]$$

where, g and f are light wavelength-related Mie scattering model parameters; and the angle parameters θ_{ij,q}^{PS}(t) and θₘ_{_{2n,q}}^{PS}(t) obtained in Step S4033 are substituted in the expression of the particle scattering phase function, to obtain the radiation powers of the propagation components after particle scattering within a unit solid angle in the propagation direction respectively; and
Step S504: calculating a wavelength range-related equivalent reflection coefficient, expressed as:

$${Γ}_{ij , {λ}_{T} , n} = {\int }_{{λ}_{1}}^{{λ}_{2}} {Φ}_{i j} ( λ ) {ρ}_{n} ( λ ) d λ$$

where, Φᵢⱼ(λ) is a radiation power spectrum density of the LED cell Lᵢⱼ, varying with wavelength, ρₙ(λ) is a reflectivity of the nth object reflection cluster, varying with wavelength, and [λ₁, λ₂] is a wavelength range of the color of the light emitted by an LED lamp.

In an embodiment of the present application, the step S6 further includes:
Step S601: calculating a channel impulse response of a direct propagation component, specifically comprising:
Step S6011: calculating a ray power of a direct propagation component, expressed as:

$${P}_{i j}^{L} ( t ) = {F}_{i j} ( {\tilde{ψ}}_{ij , E , L}^{{}_{T}} ( t ) , {\tilde{ψ}}_{ij , A , L}^{{}_{T}} ( t ) ) \cdot \frac{{A}_{R} cos ( {ψ}_{i j , L}^{R} ( t ) )}{{( {D}_{i j} ( t ) )}^{2}} \cdot G ( {ψ}_{i j , L}^{R} ( t ) ) T ( {ψ}_{i j , L}^{R} ( t ) ) V ( {ψ}_{i j , L}^{R} ( t ) ) \cdot exp ( - {k}_{e} {D}_{i j} ( t ) )$$

where, at the frequency bands of infrared light and visible light in an indoor scenario, if kₑ=0, the model is reduced to a model supporting infrared light and visible light, and a particle extinction attenuation is 1;
Step S6012: calculating a propagation delay of a direct propagation component, expressed as:

$${τ}_{i j}^{L} ( t ) = {D}_{i j} ( t ) / {c}_{l}$$

where, cₗ is the speed of light; and
Step S6013: generating a channel impulse response of a direct component in each subchannel according to the parameters calculated in Step S6011 and Step S6012, expressed as:

$${h}_{i j}^{L} ( t , τ ) = {P}_{i j}^{L} ( t ) \cdot δ ( τ - {τ}_{i j}^{L} ( t ) )$$

Step S602: calculating a channel impulse response of an indirect propagation component, specifically comprising:
Step S6021: calculating a ray power of a propagation component that is emitted from Lᵢⱼ and reaches the receiver simply through particle scattering, expressed as:

$${P}_{ij , q}^{N} ( t ) = {F}_{i j} ( {\tilde{ψ}}_{ij , E , q}^{{}_{T}} ( t ) , {\tilde{ψ}}_{ij , A , q}^{{}_{T}} ( t ) ) \times \frac{{k}_{s} exp ( - {k}_{e} {d}_{i j , q}^{T} ( t ) )}{{( {d}_{i j , q}^{T} ( t ) )}^{2}} \cdot {V}_{q , eff} \times P ( {θ}_{ij , q}^{P S} ( t ) ) exp ( - {k}_{e} {d}_{q}^{R} ( t ) ) \frac{{A}_{R} cos ( {ψ}_{q}^{R} ( t ) )}{{( {d}_{q}^{R} ( t ) )}^{2}} \times G ( {ψ}_{q}^{R} ( t ) ) T ( {ψ}_{q}^{R} ( t ) ) V ( {ψ}_{q}^{R} ( t ) )$$

where, V_{q,eff} is an equivalent volume of each scatterer in the particle scattering cluster, related to an equivalent volume V_{c,eff} of the particle scattering cluster, and calculated as V_{q,eff}=V_{c,eff}/Q^{PS}, and Q^{PS} is the number of scatterers in the particle scattering cluster; and G(ψ^{R}) and T(ψ^{R}) are an optical focusing lens gain and an optical filter gain respectively, V(ψ^{R}) is a viewshed function, and V(ψ^{R}) is expressed as:

$$V ( {ψ}^{R} ) = \{ \begin{matrix}1 , & 0 \leq {ψ}^{R} \leq {Ψ}_{F o V} \\ 0 , & {ψ}^{R} > {Ψ}_{F o V}\end{matrix}$$

Step S6022: calculating a ray delay of a propagation component that is emitted from Lᵢⱼ and reaches the receiver simply through particle scattering, expressed as:

$${τ}_{ij , q}^{{}_{N}} ( t ) = ( {d}_{i j , q}^{T} ( t ) + {d}_{q}^{R} ( t ) ) / {c}_{l}$$

Step S6023: calculating a ray power of a propagation component that is emitted from Lᵢⱼ and reaches the receiver simply through object reflection, in the case of single reflection, expressed as:

$${P}_{ij , {m}_{1 n}}^{N} ( t ) = {F}_{i j} ( {\tilde{ψ}}_{ij , E , {m}_{1 n}}^{{}_{T}} ( t ) , {\tilde{ψ}}_{ij , A , {m}_{1 n}}^{{}_{T}} ( t ) ) \times \frac{{A}_{s , eff} cos ( {ψ}_{ij , {m}_{1 n}}^{S , T} ( t ) )}{{( {d}_{i j , {m}_{1 n}}^{T} ( t ) )}^{2}} \times {Γ}_{ij , {λ}_{T} , n} {R}_{n} ( {ψ}_{{m}_{1 n}}^{S , R , 1} ( t ) , {ψ}_{{m}_{1 n}}^{S , R , 2} ( t ) ) \frac{{A}_{R} cos ( {{ψ}_{{m}_{1 n}}^{R}}^{} ( t ) )}{{( {d}_{{m}_{1 n}}^{R} ( t ) )}^{2}} \times G ( {ψ}_{{m}_{1 n}}^{R} ( t ) ) T ( {ψ}_{{m}_{1 n}}^{R} ( t ) ) V ( {ψ}_{{m}_{1 n}}^{R} ( t ) ) \times exp [ - {k}_{e} ( {d}_{i j , {m}_{1 n}}^{T} ( t ) + {d}_{{m}_{1 n}}^{R} ( t ) ) ]$$

wherein, in the case of double object reflection, a channel is characterized by two clusters located at the transmitter and the receiver respectively; and compared with the single reflection, the calculation of the ray power adds a power loss from a transmitting-end scatterer to a receiving-end scatterer;
Step S6024: calculating a ray power of a propagation component that is emitted from Lᵢⱼ and reaches the receiver simply through object reflection, in the case of single reflection, expressed as:

$${τ}_{ij , {m}_{1 n}}^{N} ( t ) = ( {d}_{i j , {m}_{1 n}}^{T} ( t ) + {d}_{{m}_{1 n}}^{R} ( t ) ) / {c}_{l}$$

in the case of double reflection, expressed as:

$${τ}_{ij , {m}_{1 n}}^{N} ( t ) = ( {d}_{i j , {m}_{1 n}}^{T} ( t ) + {d}_{{m}_{1 n}}^{RE - RE} ( t ) + {d}_{{m}_{1 n}}^{R} ( t ) ) / {c}_{l}$$

Step S6025: calculating a ray power of a propagation component that is emitted from Lᵢⱼ and undergoes object reflection and then particle scattering, expressed as:

$${P}_{ij , {m}_{2 n} , q}^{N} ( t ) = {F}_{i j} ( {\tilde{ψ}}_{ij , E , {m}_{2 n}}^{{}_{T}} ( t ) , {\tilde{ψ}}_{ij , A , {m}_{2 n}}^{{}_{{}_{T}}} ( t ) ) exp ( - {k}_{e} {d}_{i j , {m}_{2 n}}^{T} ( t ) ) \times \frac{{A}_{s , eff} cos ( {ψ}_{ij , {m}_{2 n}}^{S , T} ( t ) )}{{( {d}_{i j , {m}_{2 n}}^{T} ( t ) )}^{2}} \times {Γ}_{ij , {λ}_{T} , n} {R}_{n} ( {ψ}_{{m}_{2 n} , q}^{S , R , 1} ( t ) , {ψ}_{{m}_{2 n} , q}^{S , R , 2} ( t ) ) \times \frac{{k}_{s} exp ( - {k}_{e} {d}_{{m}_{2 n} , q}^{RE - PS} ( t ) )}{{( {d}_{{m}_{2 n} , q}^{RE - PS} ( t ) )}^{2}} \cdot {V}_{q , eff} \times P ( {θ}_{{m}_{2 n} , q}^{P S} ( t ) ) exp ( - {k}_{e} {d}_{q}^{R} ( t ) ) \frac{{A}_{R} cos ( {ψ}_{q}^{R} ( t ) )}{{( {d}_{q}^{R} ( t ) )}^{2}} \times G ( {ψ}_{q}^{R} ( t ) ) T ( {ψ}_{q}^{R} ( t ) ) V ( {ψ}_{q}^{R} ( t ) )$$

wherein a signal passes through random Mₙ·p_{particle} scatterers in each object reflection cluster before particle scattering, and it is determined whether a ray in the object reflection cluster undergoes single object reflection and then particle scattering before reaching the receiver according to the 0/1 random numbers for propagation component classification generated in Step S202;
Step S6026: calculating a propagation delay of a propagation component that is emitted from Lᵢⱼ and undergoes object reflection and then particle scattering, expressed as:

$${τ}_{ij , {m}_{2 n} , q}^{N} ( t ) = ( {d}_{ij , {m}_{2 n}}^{T} ( t ) + {d}_{{m}_{2 n} , q}^{RE - PS} ( t ) + {d}_{q}^{R} ( t ) ) / {c}_{l}$$

Step S6027: generating a channel impulse response of a direct component in each subchannel according to the parameters calculated in Step S6021 and Step S6026, expressed as:

$${h}_{ij}^{N} ( t , τ ) = ⌈ {p}_{p a r t i c l e} ⌉ \cdot {\sum }_{q = 1}^{{Q}^{P S}} {P}_{ij , q}^{N} ( t ) \cdot δ ( τ - {τ}_{ij , q}^{N} ( t ) ) + {\sum }_{n = 1}^{{N}_{i j} ( t )} {\sum }_{{m}_{1} = 1}^{{M}_{n} \cdot ( 1 - {p}_{particle} )} {P}_{ij , {m}_{1 n}}^{N} ( t ) \cdot δ ( τ - {τ}_{ij , {m}_{1 n}}^{N} ( t ) ) + {\sum }_{n = 1}^{{N}_{i j} ( t )} {\sum }_{{m}_{2} = 1}^{{M}_{n} \cdot {p}_{particle}} {P}_{ij , {m}_{2 n} , q}^{N} ( t ) \cdot δ ( τ - {τ}_{ij , {m}_{2 n} , q}^{N} ( t ) )$$

where, Nᵢⱼ(t) denotes the number of clusters of a subchannel from the LED cell Lᵢⱼ to the receiver at a moment t; and at the frequency bands of infrared light and visible light in an indoor scenario, if p_{particle}=0 and kₑ=0, the model is reduced to a model supporting infrared light and visible light, only an indirect component that reaches the receiver through object reflection exists, and the particle extinction attenuation of the indirect component calculated in Step S6023 is 1;
Step S603: determining whether an indirect component corresponding to the object reflection cluster exists according to the birth-death matrix generated in Step S201, and setting a contribution of an invisible link to the channel impulse response to zero; and
Step S604: determining whether a direct component exists in each subchannel according to the random number matrix for controlling whether a direct component exists generated in Step S202, to obtain a final channel impulse response.

The general geometry-based stochastic channel modeling method for indoor optical wireless communications of the embodiments of the present invention integrate the common characteristics of the frequency bands of optical wireless communications in indoor scenarios with the typical characteristics of the frequency bands of infrared light, visible light and ultraviolet light. By setting corresponding parameters, the established model can be reduced to an optical wireless channel model for a corresponding band, to be flexibly applied to the simulation and performance evaluation of 6G indoor optical wireless communication systems.

Additional aspects and advantages of the present application will be partially given in the following description, and will partially become apparent from the following description or be understood from the practice of the present application.

### BRIEF DESCRIPTION OF THE DRAWINGS

The above-mentioned and/or additional aspects and advantages of the present application will become apparent and easy to understand from the description below of the embodiments in conjunction with accompanying drawings, where:

FIG. 1 is a flowchart of an indoor optical wireless communications-oriented general geometry-based stochastic channel modeling method according to the embodiments of the present application; and

FIG. 2 is a schematic diagram of a three-dimensional general geometry-based stochastic channel model for indoor optical wireless communications according to the embodiments of the present application.

### DETAILED DESCRIPTION OF THE EMBODIMENTS

The embodiments of the present application are described below in detail, and examples of the embodiments are shown in the accompanying drawings, where the consistently identical or similar numbers represent identical or similar components or components having identical or similar functions. The embodiments described below with reference to the accompanying drawings are exemplary and are intended to explain the present application, but should not be construed as limiting the present application.

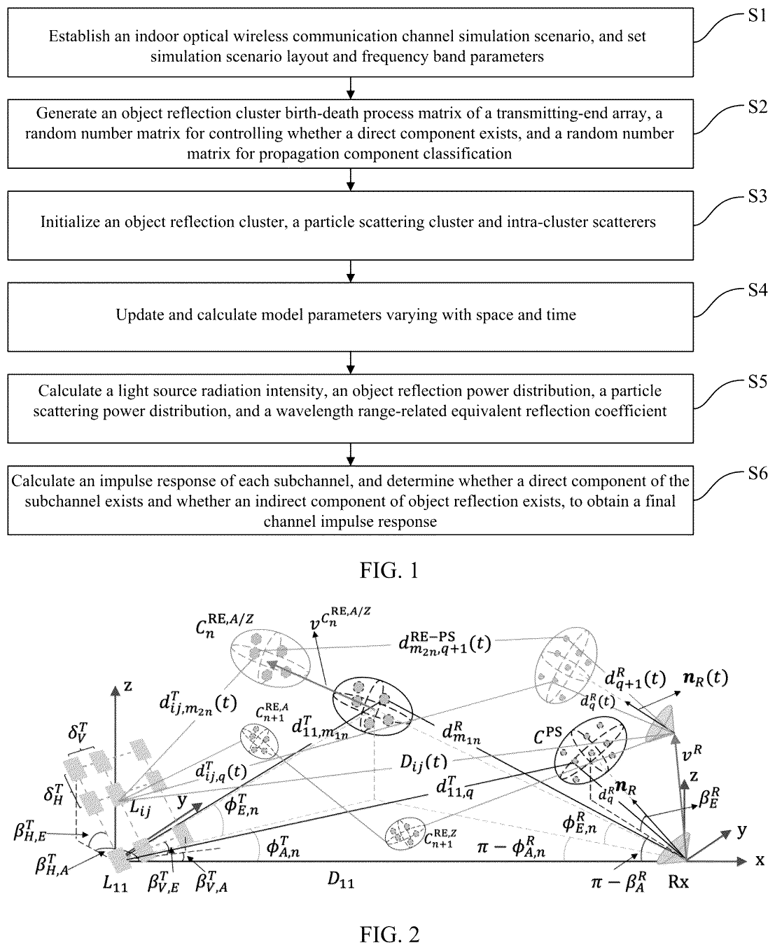

FIG. 1 is a flowchart of an indoor optical wireless communications-oriented general geometry-based stochastic channel modeling method according to the embodiments of the present application.

As shown in FIG. 1, the indoor optical wireless communications-oriented general geometry-based stochastic channel modeling method includes the following steps:
Step S1: an indoor optical wireless communication channel simulation scenario is established, and simulation scenario layout and frequency band parameters are set.

Specifically, in this embodiment, the step S1 includes:
Step S101: establishing an indoor optical wireless communication channel simulation scenario, comprising an LED array serving as a transmitter, and a photoelectric detector serving as receiver, and a global coordinate system is established by defining a ray from the first-row and first-column LED cell at the transmitter to the receiver as an x axis, and taking a plane perpendicular to the same as a yoz plane;
Step S102: setting physical environment parameters of the scenario layout, comprising transmitter parameters, receiver parameters, distance parameters and blocking effect parameters;
Step S1021: setting the transmitting-end parameters, comprising direction parameters of the LED array, a number M_{I} and a cell spacing δ_{H}^{T} of the LED cells of the LED array in the horizontal direction, and a number M_{J} and a cell spacing δ_{V}^{T} of the LED cells of the LED array in the vertical direction, wherein the direction parameters of the LED array comprise an azimuth angle β_{H,A}^{T} and an elevation angle β_{H,E}^{T} of the LED array in the horizontal direction, and an azimuth angle β_{V,A}^{T} and an elevation angle β_{V,E}^{T} of the LED array in the vertical direction;
Step S1022: setting the receiving-end parameters, comprising an azimuth angle β_{A}^{R} and an elevation angle β_{E}^{R} of the normal of the receiver, an area A_{R} of the receiver, a viewing angle Ψ_{FoV} at the receiver, a translational azimuth angle α_{A}^{R}(t) and an elevation angle α_{E}^{R}(t) as well as a velocity v^{R}(t) of the receiver, and a rotational azimuth angular velocity ω_{A}^{R}(t) and an elevation angular velocity ω_{E}^{R}(t) of the receiver;
Step S1023: setting the distance parameters, comprising a distance D₁₁ from the first-row and first-column LED cell L₁₁ of the LED array to the receiver; and
Step S1024: setting the blocking effect parameters, comprising a probability p_{blockage} of a line-of-sight component being blocked.
Step S103: setting frequency band-related parameters, comprising a proportion η_{SB} of single-cluster propagation, a probability p_{particle} of a propagation component being scattered by particles in the environment, a proportion αₙ of diffuse reflection of a light signal on a material in the environment, a spread parameter σ^{RE} of the object reflection cluster, a spread parameter σ^{PS} of the particle scattering cluster, a particle extinction coefficient kₑ, a particle Rayleigh scattering coefficient kₛᵣ, and a particle Mie scattering coefficient kₛₘ, where, in the frequency band of ultraviolet light, due to a large path loss, only single-cluster propagation is taken into account, so the proportion of single-cluster propagation is set to 1; the effects of particle scattering and extinction on the frequency band of ultraviolet light need to be considered, so none of the particle scattering probability p_{particle}, the particle extinction coefficient kₑ, the particle Rayleigh scattering coefficient kₛᵣ and particle Mie scattering coefficient kₛₘ, and the spread parameter σ^{PS} of the particle scattering cluster is zero; in the frequency bands of infrared light and visible light, double-cluster propagation is usually taken into account while the effects of particle scattering and extinction do not need to be considered, and p_{particle} and kₑ, kₛᵣ, kₛₘ and σ^{PS} are all set to zero; and as the frequency band rises, a light signal is more likely to be diffusely reflected, and the proportion αₙ of diffuse reflection of the light signal on the material in the environment and the spread parameter σ^{RE} of the object reflection cluster are increased.
Step S2: an object reflection cluster birth-death process matrix of a transmitting-end array, a random number matrix for controlling whether a direct component exists, and a random number matrix for propagation component classification are generated.

Specifically, in this embodiment, the step S2 includes:
Step S201: generating an object reflection cluster birth-death process matrix of a transmitting-end array, specifically comprising:
Step S2011: calculating a number N_{c0} of the clusters seen by the LED cell L₁₁ at the initial moment, expressed as:

$${N}_{c 0} = \frac{{λ}_{B}}{{λ}_{D}}$$

where, λ_{B} and λ_{D} are the birth and death rates of the clusters respectively;
Step S2012: generating a visibility matrix of the first-column LED cells L₁₁-L_{M}_{_{I}}₁ for the clusters based on the LED cell L₁₁, wherein column evolution is performed in the horizontal direction, and a survival probability of the clusters in a spacing of δ_{H}^{T} is:

$${P}_{H , remain} ( {δ}_{H}^{T} ) = exp ( - {λ}_{B} \cdot \frac{{δ}_{H}^{T} cos ( {β}_{H , E}^{T} )}{{D}_{c}^{A}} )$$

where, D_{C}^{A} is an array-related factor associated with a specific scenario;
the number of the newly generated clusters follows a Poisson distribution, with a mean of:

$$𝔼 ( {N}_{N e w , H} ) = \frac{{λ}_{B}}{{λ}_{D}} [ 1 - {P}_{H , r e m a i n} ( {δ}_{H}^{T} ) ]$$

Step S2013: generating a visibility matrix of the LED cells in each column for the clusters based on the first-column LED cells L₁₁-L_{M}_{_{I}}₁ generated in Step S2012, wherein column evolution is performed in the vertical direction, and a survival probability of the clusters in a spacing of δ_{V}^{T} is:

$${P}_{V , remain} ( {δ}_{V}^{T} ) = exp ( - {λ}_{B} \cdot \frac{{δ}_{V}^{T} cos ( {β}_{V , E}^{T} )}{{D}_{c}^{A}} )$$

the number of the newly generated clusters follows a Poisson distribution, with a mean of:

$$𝔼 ( {N}_{N e w , V} ) = \frac{{λ}_{B}}{{λ}_{D}} [ 1 - {P}_{V , r e m a i n} ( {δ}_{V}^{T} ) ]$$

Step S2014: generating a final object reflection cluster birth-death process matrix, namely, a matrix with dimensions of M_{I}×M_{J}×N_{c,total}, wherein the total number N_{c,total} of the object reflection clusters is equal to the sum of N_{c0} and the number of the newly generated clusters; and
Step S202: calculating an existence probability p_{LoS}=(1−p_{blockage})·(1−p_{particle}) of a direct component, and generating a 0/1 random number matrix for controlling whether the direct component exists according to the probability, with dimensions of M_{I}×M_{J}; and generating Mₙ 0/1 random numbers according to p_{particle}, and classifying a propagation component according to whether the propagation component after object reflection further undergoes scattering before reaching the receiver, wherein Mₙ is the number of scatterers in the object reflection cluster.
Step S3: an object reflection cluster, a particle scattering cluster and intra-cluster scatterers are initialized.

Specifically, in this embodiment, the step S3 includes:
Step S301: stochastically generating a position of the object reflection cluster at the initial moment, the initial position of the cluster determined by azimuth angle, elevation angle and distance parameters, specifically comprising:
Step S3011: stochastically generating the angle parameters of N_{c,total} object reflection clusters, and modeling the same to follow a wrapped Gaussian distribution, where, for example, an elevation angle of departure ϕ_{E,n}^{T} and an azimuth angle of departure ϕ_{A,n}^{T} of the object reflection cluster at the transmitter may be generated by the following assumptions:

$${ϕ}_{E , n}^{T} = std [ {ϕ}_{E , n}^{T} ] {Y}_{E , n}^{T} + {\overline{ϕ}}_{E , n}^{{}_{T}} \\ {ϕ}_{A , n}^{T} = std [ {ϕ}_{E , n}^{T} ] {Y}_{A , n}^{T} + {\overline{ϕ}}_{A , n}^{{}_{T}}$$

where, Y_{E,n}^{T}, Y_{A,n}^{T}˜ [symbol] (0,1), std[ϕ_{E,n}^{T}] and std[ϕ_{E,n}^{T}] are the variances of the elevation angle of departure and azimuth angle of departure of the object reflection cluster respectively, and ϕ̅_{E,n}^{T} and ϕ̅_{A,n}^{T} are the means of the elevation angle of departure and azimuth angle of departure of the object reflection cluster respectively; and similarly, the angle parameters of the object reflection clusters at N_{c,total}×(1−η_{SB}) receivers are generated;
Step S3012: stochastically generating distances dₙ^{T} and dₙ^{R} from the object reflection cluster to the LED unit L₁₁ at the initial moment, wherein a non-negative exponential distribution is followed;
Step S302: calculating an equivalent normal direction and an equivalent mirror reflection direction of each object reflection cluster according to a geometric relationship. In the case of single object reflection, an equivalent normal points from the cluster center to a ray from L₁₁ to the receiver, and is perpendicular to the ray, an equivalent mirror reflection direction vector is in the same plane as the cluster center, L₁₁ and the receiver, and an angle formed with the equivalent normal is equal to an angle between a vector from the cluster center to L₁₁ and the equivalent normal. In the case of double object reflection, an equivalent normal of a transmitting-end cluster points from the cluster center to a ray from L₁₁ to a receiving-end cluster and is perpendicular to the ray, an equivalent mirror reflection direction vector thereof is in the same plane as the cluster center, L₁₁ and the receiving-end cluster, and an angle formed with the equivalent normal is equal to an angle between a vector from the cluster center to L₁₁ and the equivalent normal, an equivalent normal of the receiving-end cluster points from the cluster center to a ray from the transmitting-end cluster to the receiver and is perpendicular to the ray, an equivalent mirror reflection direction vector thereof is in the same plane as the cluster center, the transmitting-end cluster and receiver, and an angle formed with the equivalent normal is equal to an angle between a vector from the cluster center to the transmitting-end cluster and the equivalent normal;
Step S303: generating a particle scattering cluster representing a particle scattering effect of an ultraviolet light signal at the receiver, wherein a ray from the receiver to the center of the particle scattering cluster is kept consistent with the normal direction of the receiver in azimuth angle and elevation angle, and a distance from the center of the particle scattering cluster to the receiver is set to a constant; and
Step S304: stochastically generating the coordinates of each intra-cluster scatterer in the global coordinate system, specifically comprising:
Step S3041: stochastically generating the coordinates [x′, y′, z′]^{T} of each intra-cluster scatterer in a local coordinate system with the cluster center as the origin, following a three-dimensional elliptical Gaussian distribution, expressed as:

$$p ( {x}^{′} , {y}^{′} , {z}^{′} ) = \frac{exp ( - \frac{{x}^{′2}}{2 {σ}_{DS}^{2}} - \frac{{y}^{′2}}{2 {σ}_{A S}^{2}} - \frac{{z}^{′2}}{2 {σ}_{B S}^{2}} )}{{( 2 π )}^{\frac{3}{2}} {σ}_{D S} {σ}_{A S} {σ}_{E S}}$$

where, σ_{DS} and σ_{AS}, σ_{ES} represent intra-cluster delay spread, angular spread and elevation spread respectively, and different cluster spread parameters are substituted for the generation of the object reflection cluster and the particle scattering cluster; and
Step S3042: obtaining the coordinates [x, y, z]^{T} of each scatterer in the global coordinate system through coordinate transformation, expressed as:

$$[ \begin{matrix}x \\ y \\ z\end{matrix} ] = [ \begin{matrix}cos ( {\overline{ϕ}}_{A} ) & - sin ( {\overline{ϕ}}_{A} ) & 0 \\ sin ( {\overline{ϕ}}_{A} ) & cos ( {\overline{ϕ}}_{A} ) & 0 \\ 0 & 0 & 1\end{matrix} ] [ \begin{matrix}cos ( {\overline{ϕ}}_{E} ) & 0 & - sin ( {\overline{ϕ}}_{E} ) \\ 0 & 1 & 0 \\ sin ( {\overline{ϕ}}_{E} ) & 0 & cos ( {\overline{ϕ}}_{E} )\end{matrix} ] [ \begin{matrix}{x}^{′} + \overline{d} \\ {y}^{′} \\ {z}^{′}\end{matrix} ]$$

where d̅, ϕ̅_{A} and ϕ̅_{E} represent an average distance, an azimuth angle and an elevation angle of a cluster respectively.
Step S4: model parameters varying with space and time are updated and calculated.

Specifically, in this embodiment, the step S4 includes:
Step S401: updating the coordinates of the scatterers and the receiver in the global coordinate system at each moment, and calculating the coordinates of Lᵢⱼ in the global coordinate system according to a geometric relationship and the set movement velocity of the object reflection cluster, and the movement and rotation velocity of the receiver; and note that the position of a scatterer in the particle scattering cluster changes synchronously with the movement and rotation of the receiver, the direction of a ray from the receiver to the center of the particle scattering cluster is always consistent with the normal direction of the receiver, and the distance from the center of the particle scattering cluster to the receiver remains unchanged;
Step S402: updating and calculating the angle parameters of each propagation ray in the local coordinate system of each LED cell, specifically comprising:
Step S4021: establishing a local coordinate system of an LED cell Lᵢⱼ, with the cell Lᵢⱼ in the ith row and jth column of the LED array as an origin, the normal direction of the LED array as an x′ᵢⱼ axis, the vertical direction of the LED array as a y′ᵢⱼ axis, and the horizontal direction of the LED array as a z′ᵢⱼ axis; and
Step S4022: performing a rotation transformation first on the Cartesian coordinates of each scatterer in the global coordinate system obtained in Step S3042 to obtain the Cartesian coordinates of the local coordinate system of the LED cell L₁₁, then, performing a translation transformation to obtain the Cartesian coordinates of the local coordinate system of the LED cell Lᵢⱼ, and at last, transforming the Cartesian coordinates of the local coordinate system of the LED cell Lᵢⱼ into spherical coordinates, to obtain an elevation angle of departure and an azimuth angle of departure of each propagation ray in the local coordinate system of the LED cell Lᵢⱼ, comprising an elevation angle of departure \tilde{ψ}_{ij,E,L}^{T}(t) and an azimuth angle of departure \tilde{ψ}_{ij,A,L}^{T}(t) of a direct path in the Lᵢⱼ local coordinate system, an elevation angle of departure \tilde{ψ}_{ij,E,q}^{T}(t) and an azimuth angle of departure \tilde{ψ}_{ij,A,q}^{T}(t) of a ray from Lᵢⱼ to the qth scatterer in the particle scattering cluster in the Lᵢⱼ local coordinate system, and an elevation angle of departure \tilde{ψ}_{ij,E,m}_{₁₍₂₎ₙ}^{T}(t) and an azimuth angle of departure \tilde{ψ}_{ij,A,m}_{₁₍₂₎ₙ}^{T}(t) of a ray from Lᵢⱼ to the m₁ (m₂)th scatterer in the nth object reflection cluster at the transmitter in the Lᵢⱼ local coordinate system;
Step S403: updating and calculating the angle parameters of each propagation ray according to the global coordinates of each scatterer and the receiver updated in Step S401, specifically comprising:
Step S4031: determining whether a ray in a single object reflection cluster reaches the receiver simply by a single reflection according to the 0/1 random numbers for propagation component classification generated in Step S202, where the ray passes through the m₁th scatterer in the nth single object reflection cluster to directly reach the receiver, but the ray undergoes particle scattering after passing through the m₂th scatterer in the nth single object reflection cluster before reaching the receiver;
Step S4032: obtaining normalized transmission vectors according to a coordinate method, comprising a normalized direction vector r_{ij,L}^{T}(t) from Lᵢⱼ to the receiver, a normalized direction vector r_{ij,q}^{T}(t) from Lᵢⱼ to the qth scatterer in the particle scattering cluster, a normalized direction vector r_{q}^{R}(t) from the qth scatterer in the particle scattering cluster to the receiver, a normalized direction vector r_{ij,m}_{₁₍₂₎ₙ}^{T}(t) from Lᵢⱼ to the m₁ (m₂)th scatterer in the nth object reflection cluster at the transmitter, a normalized direction vector rₘ_{₁₍₂₎ₙ}^{R}(t) from the m₁ (m₂)th scatterer in the nth object reflection cluster at the transmitter to the receiver, a normalized direction vector rₘ_{₁ₙ}^{RE-RE}(t) from the m₁th scatterer in the nth object reflection cluster at the transmitter to the m₁th scatterer in the nth object reflection cluster at the receiver, and a normalized direction vector rₘ_{_{2n,q}}^{RE-PS}(t) from the m₂th scatterer in the nth object reflection cluster at the transmitter to the qth scatterer in the particle scattering cluster; and
Step S4033: updating and calculating the angle parameters of each propagation component according to the cosine law, comprising an angle ψ_{ij,L}^{R}(t) between −r_{ij,L}^{T}(t) and the normal direction of the receiver, an angle θ_{ij,q}^{PS}(t) between r_{ij,q}^{T}(t) and r_{q}^{R}(t), an angle ψ_{q}^{R}(t) between −r_{q}^{R}(t) and the normal direction of the receiver, an angle ψ_{ij,m}_{₁₍₂₎ₙ}^{S,T}(t) between −r_{ij,m}_{₁₍₂₎ₙ}^{T}(t) and the equivalent normal direction of, the nth object reflection cluster at the transmitter, angles ψₘ_{₁ₙ}^{S,R,1}(t) and ψₘ_{₁ₙ}^{S,R,2}(t) between rₘ_{₁ₙ}^{R}(t) and the equivalent normal direction and equivalent mirror reflection direction of the nth object reflection cluster at the transmitter, an angle ψₘ_{₁ₙ}^{R}(t) between −rₘ_{₁ₙ}^{R}(t) and the normal direction of the receiver, angles ψₘ_{_{2n,q}}^{S,R,1}(t), ψₘ_{_{2n,q}}^{S,R,2}(t) between rₘ_{_{2n,q}}^{RE-PS}(t) and the equivalent normal direction and equivalent mirror reflection direction of the nth object reflection cluster at the transmitter, and an angle θₘ_{_{2n,q}}^{PS}(t) between rₘ_{_{2n,q}}^{RE-PS}(t) and r_{q}^{R}(t); and
Step S404: updating and calculating the propagation distance parameters of each propagation ray at each moment according to the global coordinates of the scatterers, Lᵢⱼ and the receiver updated in Step S401 and a coordinate method, comprising a distance Dᵢⱼ(t) from Lᵢⱼ to the receiver, a distance d_{ij,q}^{T}(t) from Lᵢⱼ to the qth scatterer in the particle scattering cluster, a distance d_{q}^{R}(t) from the qth scatterer in the particle scattering cluster to the receiver, a distance d_{ij,m}_{₁₍₂₎ₙ}^{T}(t) from Lᵢⱼ to the m₁ (m₂)th scatterer in the nth object reflection cluster at the transmitter, a distance dₘ_{₁₍₂₎ₙ}^{R}(t) from the m₁ (m₂)th scatterer in the nth object reflection cluster at the transmitter to the receiver, a distance dₘ_{₁ₙ}^{RE-RE}(t) from the m₁th scatterer in the nth object reflection cluster at the transmitter to the m₁th scatterer in the n object reflection cluster at the receiver, and a distance dₘ_{_{2n,q}}^{RE-PS}(t) from the m₂th scatterer in the nth object reflection cluster at the transmitter to the qth scatterer in the particle scattering cluster.
Step S5: a light source radiation intensity, an object reflection power distribution, a particle scattering power distribution, and a wavelength range-related equivalent reflection coefficient are calculated.

Specifically, in this embodiment, the step S5 includes:
Step S501: calculating a light source radiation intensity in a direction corresponding to the propagation ray, expressed as:

$${F}_{i j} ( {\tilde{ψ}}_{ij , E}^{T} , {\tilde{ψ}}_{ij , A}^{T} ) = \frac{α + 1}{2 π} {cos}^{α} ( {\tilde{ψ}}_{ij , E}^{T} ) {cos}^{α} ( {\tilde{ψ}}_{ij , A}^{T} )$$

where, α is a mode number of a Lambertian radiation mode; and the angle parameters obtained in Step S4022 are substituted in the equation above to calculate a light source radiation intensity corresponding to each propagation component;
Step S502: calculating a power distribution of the propagation ray after object reflection according to a Phong's reflection model, expressed as:

$${R}_{n} ( {ψ}_{n}^{S , R , 1} ( t ) , {ψ}_{n}^{S , R , 2} ( t ) ) = {α}_{n} \frac{cos ( {ψ}_{n}^{S , R , 1} ( t ) )}{π} + ( 1 - {α}_{n} ) \frac{{m}_{s n} + 1}{2 π} {cos}^{{m}_{s n}} ( {ψ}_{n}^{S , R , 2} ( t ) )$$

where, mₛₙ is a directional parameter of a mirror reflection component; and the angle parameters between the propagation ray and the equivalent normal direction and equivalent mirror reflection direction of the object reflection cluster obtained in Step S4033 are substituted in the equation above, to calculate the radiation powers of the propagation components after object reflection within a unit solid angle in the propagation direction;
Step S503: calculating a power distribution of the propagation ray after particle scattering according to a particle scattering phase function, expressed as:

$$P ( {θ}^{P S} ) = \frac{{k}_{s , r}}{{k}_{s}} {P}_{r} ( {θ}^{P S} ) + \frac{{k}_{s , m}}{{k}_{s}} {P}_{m} ( {θ}^{P S} )$$

where, kₛ is a scattering coefficient, equal to the sum of a particle Rayleigh scattering coefficient kₛᵣ and a particle Mie scattering coefficient kₛₘ, and Pᵣ(θ^{PS}) and Pₘ(GPS) are a Rayleigh scattering phase function and a Mie scattering phase function respectively, wherein,
Pᵣ(θ^{PS}) is expressed as:

$${P}_{r} ( {θ}^{P S} ) = \frac{3 [ 1 + 3 γ + ( 1 - γ ) {cos}^{2} {θ}^{P S} ]}{16 π ( 1 + 2 γ )}$$

where, γ is a Rayleigh scattering model parameter, determined by a depolarization factor;
Pₘ(θ^{PS}) is expressed as:

$${P}_{m} ( {θ}^{P S} ) = \frac{1 - {g}^{2}}{4 π} [ \frac{1}{{( 1 + {g}^{2} - 2 g cos {θ}^{P S} )}^{3 / 2}} + \frac{f ( 3 {cos}^{2} {θ}^{P S} - 1 )}{2 {( 1 + {g}^{2} )}^{3 / 2}} ]$$

where, g and f are light wavelength-related Mie scattering model parameters; and the angle parameters θ_{ij,q}^{PS}(t) and θₘ_{_{2n,q}}^{PS}(t) obtained in Step S4033 are substituted in the expression of the particle scattering phase function, to obtain the radiation powers of the propagation components after particle scattering within a unit solid angle in the propagation direction respectively; and
Step S504: calculating a wavelength range-related equivalent reflection coefficient, expressed as:

$${Γ}_{ij , {λ}_{T} , n} = {\int }_{{λ}_{1}}^{{λ}_{2}} {Φ}_{i j} ( λ ) {ρ}_{n} ( λ ) d λ$$

where, Φᵢⱼ(λ) is a radiation power spectrum density of the LED cell Lᵢⱼ, varying with wavelength, ρₙ(λ) is a reflectivity of the nth object reflection cluster, varying with wavelength, and [λ₁, λ₂] is a wavelength range of the color of the light emitted by an LED lamp, set according to the light signal in use.

Specifically, in this embodiment, the step S6 includes:
Step S601: calculating a channel impulse response of a direct propagation component, specifically comprising:
Step S6011: calculating a ray power of a direct propagation component, expressed as:

$${P}_{i j}^{L} ( t ) = {F}_{i j} ( {\tilde{ψ}}_{ij , E , L}^{T} ( t ) , {\tilde{ψ}}_{ij , A , L}^{T} ( t ) ) \cdot \frac{{A}_{R} cos ( {ψ}_{i j , L}^{R} ( t ) )}{{( {D}_{i j} ( t ) )}^{2}} \cdot G ( {ψ}_{i j , L}^{R} ( t ) ) T ( {ψ}_{i j , L}^{R} ( t ) ) T ( {ψ}_{i j , L}^{R} ( t ) ) \cdot exp ( - {k}_{e} {D}_{i j} ( t ) )$$

where, at the frequency bands of infrared light and visible light in an indoor scenario, without considering a particle extinction effect, if kₑ=0, the model is reduced to a model supporting infrared light and visible light, and a particle extinction attenuation is 1;
Step S6012: calculating a propagation delay of a direct propagation component, expressed as:

$${τ}_{i j}^{L} ( t ) = {D}_{i j} ( t ) / {c}_{l}$$

where, cₗ is the speed of light; and
Step S6013: generating a channel impulse response of a direct component in each subchannel according to the parameters calculated in Step S6011 and Step S6012, expressed as:

$${h}_{i j}^{L} ( t , τ ) = {P}_{i j}^{L} ( t ) \cdot δ ( τ - {τ}_{i j}^{L} ( t ) )$$

Step S602: calculating a channel impulse response of an indirect propagation component, specifically comprising:
Step S6021: calculating a ray power of a propagation component that is emitted from Lᵢⱼ and reaches the receiver simply through particle scattering, expressed as:

$${P}_{ij , q}^{N} ( t ) = {F}_{i j} ( {\tilde{ψ}}_{ij , E , q}^{T} ( t ) , {\tilde{ψ}}_{ij , A , q}^{T} ( t ) ) \times \frac{{k}_{s} exp ( - {k}_{e} {d}_{i j , q}^{T} ( t ) )}{{( {d}_{i j , q}^{T} ( t ) )}^{2}} \cdot {V}_{q , eff} \times P ( {θ}_{ij , q}^{P S} ( t ) ) exp ( - {k}_{e} {d}_{q}^{R} ( t ) ) \frac{{A}_{R} cos ( {ψ}_{q}^{R} ( t ) )}{{( {d}_{q}^{R} ( t ) )}^{2}} \times G ( {ψ}_{q}^{R} ( t ) ) T ( {ψ}_{q}^{R} ( t ) ) V ( {ψ}_{q}^{R} ( t ) )$$

where, V_{q,eff} is an equivalent volume of each scatterer in the particle scattering cluster, related to an equivalent volume V_{c,eff} of the particle scattering cluster, and calculated as V_{q,eff}=V_{c,eff}/Q^{PS}, and Q^{PS} is the number of scatterers in the particle scattering cluster; and G(ψ^{R}) and T(ψ^{R}) are an optical focusing lens gain and an optical filter gain respectively, V(ψ^{R}) is a viewshed function, and
V(ψ^{R}) is expressed as:

$$V ( {ψ}^{R} ) = \{ \begin{matrix}1 , & 0 \leq {ψ}^{R} \leq {Ψ}_{FoV} \\ 0 , & {ψ}^{R} > {Ψ}_{FoV}\end{matrix}$$

Step S6022: calculating a ray delay of a propagation component that is emitted from Lᵢⱼ and reaches the receiver simply through particle scattering, expressed as:

$${τ}_{ij , q}^{N} ( t ) = ( {d}_{i j , q}^{T} ( t ) + {d}_{q}^{R} ( t ) ) / {c}_{l}$$

Step S6023: calculating a ray power of a propagation component that is emitted from Lᵢⱼ and reaches the receiver simply through object reflection,
   in the case of single reflection, expressed as:

$${P}_{ij , {m}_{1 n}}^{N} ( t ) = {F}_{i j} ( {\tilde{ψ}}_{ij , E , {m}_{1 n}}^{T} ( t ) , {\tilde{ψ}}_{ij , A , {m}_{1 n}}^{T} ( t ) ) \times \frac{{A}_{s , e f f} cos ( {ψ}_{ij , {m}_{1 n}}^{S , T} ( t ) )}{{( {d}_{i j , {m}_{1 n}}^{T} ( t ) )}^{2}} \times {Γ}_{ij , {λ}_{T} , n} {R}_{n} ( {ψ}_{{m}_{1 n}}^{S , R , 1} ( t ) , {ψ}_{{m}_{1 n}}^{S , R , 2} ( t ) ) \frac{{A}_{R} cos ( {ψ}_{{m}_{1 n}}^{R} ( t ) )}{{( {d}_{{m}_{1 n}}^{R} ( t ) )}^{2}} \times G ( {ψ}_{{m}_{1 n}}^{R} ( t ) ) T ( {ψ}_{{m}_{1 n}}^{R} ( t ) ) V ( {ψ}_{{m}_{1 n}}^{R} ( t ) ) \times exp [ - {k}_{e} ( {d}_{i j , {m}_{1 n}}^{T} ( t ) + {d}_{{m}_{1 n}}^{R} ( t ) ) ]$$

in the case of double object reflection, a channel is characterized by two clusters located at the transmitter and the receiver respectively; and the calculation of the ray power is similar to that for single reflection, with the exception of adding a power loss from a transmitting-end scatterer to a receiving-end scatterer;
Step S6024: calculating a ray power of a propagation component that is emitted from Lᵢⱼ and reaches the receiver simply through object reflection,
   in the case of single reflection, expressed as:

$${τ}_{ij , {m}_{1 n}}^{N} ( t ) = ( {d}_{i j , {m}_{1 n}}^{T} ( t ) + {d}_{{m}_{1 n}}^{R} ( t ) ) / {c}_{l}$$

in the case of double reflection, expressed as:

$${τ}_{ij , {m}_{1 n}}^{N} ( t ) = ( {d}_{i j , {m}_{1 n}}^{T} ( t ) + {d}_{{m}_{1 n}}^{R E - R E} ( t ) + {d}_{{m}_{1 n}}^{R} ( t ) ) / {c}_{l}$$

Step S6025: calculating a ray power of a propagation component that is emitted from Lᵢⱼ and undergoes object reflection and then particle scattering, expressed as:

$${P}_{ij , {m}_{2 n} , q}^{N} ( t ) = {F}_{i j} ( {\tilde{ψ}}_{ij , E , {m}_{2 n}}^{T} ( t ) , {\tilde{ψ}}_{ij , A , {m}_{2 n}}^{T} ( t ) ) exp ( - {k}_{e} {d}_{i j , {m}_{2 n}}^{T} ( t ) ) \times \frac{{A}_{s , e f f} cos ( {ψ}_{ij , {m}_{2 n}}^{S , T} ( t ) )}{{( {d}_{i j , {m}_{2 n}}^{T} ( t ) )}^{2}} \times {Γ}_{ij , {λ}_{T} , n} {R}_{n} ( {ψ}_{{m}_{2 n} , q}^{S , R , 1} ( t ) , {ψ}_{{m}_{2 n} , q}^{S , R , 2} ( t ) ) \times \frac{{k}_{s} exp ( - {k}_{e} {d}_{{m}_{2 n} , q}^{R E - P S} ( t ) )}{{( {d}_{{m}_{2 n} , q}^{R E - P S} ( t ) )}^{2}} \cdot {V}_{q , eff} \times P ( {θ}_{{m}_{2 n} , q}^{P S} ( t ) ) exp ( - {k}_{e} {d}_{q}^{R} ( t ) ) \frac{{A}_{R} cos ( {ψ}_{q}^{R} ( t ) )}{{( {d}_{q}^{R} ( t ) )}^{2}} \times G ( {ψ}_{q}^{R} ( t ) ) T ( {ψ}_{q}^{R} ( t ) ) V ( {ψ}_{q}^{R} ( t ) )$$

wherein a signal passes through random Mₙ·p_{particle} scatterers in each object reflection cluster before particle scattering, and it is determined whether a ray in the object reflection cluster undergoes single object reflection and then particle scattering before reaching the receiver according to the 0/1 random numbers for propagation component classification generated in Step S202;
Step S6026: calculating a propagation delay of a propagation component that is emitted from Lᵢⱼ and undergoes object reflection and then particle scattering, expressed as:

$${τ}_{i j , {m}_{2 n ,} q}^{N} ( t ) = ( {d}_{i j , {m}_{2 n}}^{T} ( t ) + {d}_{{m}_{2 n} , q}^{R E - P S} ( t ) + {d}_{q}^{R} ( t ) ) / {c}_{l}$$

Step S6027: generating a channel impulse response of a direct component in each subchannel according to the parameters calculated in Step S6021 and Step S6026, expressed as:

$${h}_{i j}^{N} ( t , τ ) = ⌈ {p}_{p a r t i c l e} ⌉ \cdot {\sum }_{q = 1}^{{Q}^{P S}} {P}_{i j , q}^{N} ( t ) \cdot δ ( τ - {τ}_{ij , q}^{N} ( t ) ) + {\sum }_{n = 1}^{{N}_{ij} ( t )} {\sum }_{{m}_{1} = 1}^{{M}_{n} \cdot ( 1 - {p}_{particle} )} {P}_{ij , {m}_{1 n}}^{N} ( t ) \cdot δ ( τ - {τ}_{ij , {m}_{1 n}}^{N} ( t ) ) + {\sum }_{n = 1}^{{N}_{i j} ( t )} {\sum }_{{m}_{2} = 1}^{{M}_{n} \cdot {p}_{particle}} {P}_{ij , {m}_{2 n} , q}^{N} ( t ) \cdot δ ( τ - {τ}_{ij , {m}_{2 n} , q}^{N} ( t ) )$$

where, Nᵢⱼ(t) denotes the number of clusters of a subchannel from the LED cell Lᵢⱼ to the receiver at a moment t; and at the frequency bands of infrared light and visible light in an indoor scenario, without considering the particle scattering and extinction effects, if p_{particle}=0 and kₑ=0, the model is reduced to a model supporting infrared light and visible light, only an indirect component that reaches the receiver through object reflection exists, and the particle extinction attenuation of the indirect component calculated in Step S6023 is 1;
Step S603: determining whether an indirect component corresponding to the object reflection cluster exists according to the birth-death matrix generated in Step S201, and setting a contribution of an invisible link to the channel impulse response to zero; and
Step S604: determining whether a direct component exists in each subchannel according to the random number matrix for controlling whether a direct component exists generated in Step S202, to obtain a final channel impulse response.
Step S6: calculating an impulse response of each subchannel, and determining whether a direct component of the subchannel exists and whether an indirect component of object reflection exists, to obtain a final channel impulse response.

The general geometry-based stochastic channel modeling method for indoor optical wireless communications proposed according to the embodiments of the present invention integrate the common characteristics of the frequency bands of optical wireless communications in indoor scenarios with the typical characteristics of the frequency bands of infrared light, visible light and ultraviolet light. By setting corresponding parameters, the established model can be reduced to an optical wireless channel model for a corresponding band, to be flexibly applied to the simulation and performance evaluation of 6G indoor optical wireless communication systems.

In the description of this Specification, the descriptions of reference terminologies such as “one embodiment”, “some embodiments”, “example”, “specific example” or “some examples” mean that specific features, structures, materials or characteristics described in conjunction with the embodiment or example are included in at least one embodiment or example of the present application. In this Specification, schematic representations of the above terminologies are not necessarily targeted at the same embodiment or example. Moreover, the specific features, structures, materials or characteristics described may be integrated in an appropriate manner in any one or N embodiments or examples. In addition, without mutual contradiction, those skilled in the art may integrate and combine different embodiments or examples as well as the features of different embodiments or examples described in this Specification.

In addition, the terms “first” and “second” are only used for a purpose of description, and cannot be interpreted as indicating or implying the relative importance or implicitly specifying the quantity of the indicated technical features. Therefore, the features defined with “first” and “second” may explicitly or implicitly include at least one of such features. In the description of the present application, “N” means at least two, such as two, three, etc., unless otherwise clearly and specifically defined.

Any process or method description in a flowchart or otherwise described herein may be understood to represent a module, fragment or portion of code comprising one or N executable instructions for implementing the steps of a customized logical function or process, and the scope of the preferred embodiments of the present application includes alternative implementations in which functions may not be performed in the order shown or discussed, including performing functions in a substantially simultaneous manner or in reverse order depending on the functions involved, which should be understood by technicians in the technical field to which the embodiments of the present application belong.

What is claimed is:

1. An indoor optical wireless communications-oriented general geometry-based stochastic channel modeling method, comprising the following steps:
Step S1: establishing an indoor optical wireless communication channel simulation scenario, and setting simulation scenario layout and frequency band parameters;
Step S2: generating an object reflection cluster birth-death process matrix of a transmitting-end array, a random number matrix for controlling whether a direct component exists, and a random number matrix for propagation component classification;
Step S3: initializing an object reflection cluster, a particle scattering cluster and intra-cluster scatterers;
Step S4: updating and calculating model parameters varying with space and time;
Step S5: calculating a light source radiation intensity, an object reflection power distribution, a particle scattering power distribution, and a wavelength range-related equivalent reflection coefficient; and
Step S6: calculating an impulse response of each subchannel, and determining whether a direct component of the subchannel exists and whether an indirect component of object reflection exists, to obtain a final channel impulse response.

2. The method according to claim 1, wherein Step S1 further comprises:
Step S101: establishing an indoor optical wireless communication channel simulation scenario, wherein the indoor optical wireless communication channel simulation scenario comprises an LED array serving as a transmitter, and a photoelectric detector serving as a receiver, and a global coordinate system is established by defining a ray from the first-row and first-column LED cell at the transmitter to the receiver as an x axis, and taking a plane perpendicular to the same as a yoz plane;
Step S102: setting physical environment parameters of the simulation scenario layout, comprising transmitting-end parameters, receiving-end parameters, distance parameters and blocking effect parameters; and
Step S103: setting frequency band parameters, comprising a proportion η_{SB} of single-cluster propagation, a probability p_{particle} of a propagation component being scattered by particles in the environment, a proportion αₙ of diffuse reflection of a light signal on a material in the environment, a spread parameter σ^{RE} of the object reflection cluster, a spread parameter σ^{PS} of the particle scattering cluster, a particle extinction coefficient kₑ, a particle Rayleigh scattering coefficient kₛᵣ, and a particle Mie scattering coefficient kₛₘ.

3. The method according to claim 2, wherein the step S102 further comprises:
Step S1021: setting the transmitting-end parameters, comprising direction parameters of the LED array, a number M_{I} and a cell spacing δ_{H}^{T} of the LED cells of the LED array in the horizontal direction, and a number M_{J} and a cell spacing δ_{V}^{T} of the LED cells of the LED array in the vertical direction, wherein the direction parameters of the LED array comprise an azimuth angle β_{H,A}^{T} and an elevation angle β_{H,E}^{T} of the LED array in the horizontal direction, and an azimuth angle β_{V,A}^{T} and an elevation angle β_{V,E}^{T} of the LED array in the vertical direction;
Step S1022: setting the receiving-end parameters, comprising an azimuth angle β_{A}^{R} and an elevation angle β_{E}^{R} of the normal of the receiver, an area A_{R} of the receiver, a viewing angle Ψ_{FoV} at the receiver, a translational azimuth angle α_{A}^{R}(t) and an elevation angle α_{E}^{R}(t) as well as a velocity v^{R}(t) of the receiver, and a rotational azimuth angular velocity ω_{A}^{R}(t) and an elevation angular velocity ω_{E}^{R}(t) of the receiver;
Step S1023: setting the distance parameters, comprising a distance D₁₁ from the first-row and first-column LED cell L₁₁ of the LED array to the receiver; and
Step S1024: setting the blocking effect parameters, comprising a probability p_{blockage} of a line-of-sight component being blocked.

4. The method according to claim 3, wherein the step S2 further comprises:
Step S201: generating an object reflection cluster birth-death process matrix of a transmitting-end array, specifically comprising:
Step S2011: calculating a number N_{c0} of the clusters seen by the LED cell L₁₁ at the initial moment, expressed as:
$${N}_{c 0} = \frac{{λ}_{B}}{{λ}_{D}}$$
where, λ_{B} and λ_{D} are the birth and death rates of the clusters respectively;
Step S2012: generating a visibility matrix of the first-column LED cells L₁₁-L_{M}_{_{I}}₁ for the clusters based on the LED cell L₁₁, wherein column evolution is performed in the horizontal direction, and a survival probability of the clusters in a spacing of δ_{H}^{T} is:
$${P}_{H , remain} ( {δ}_{H}^{T} ) = exp ( - {λ}_{B} \cdot \frac{{δ}_{H}^{T} cos ( {β}_{H , E}^{T} )}{{D}_{c}^{A}} )$$
where, D_{c}^{A} is an array-related factor associated with a specific scenario;
the number of the newly generated clusters follows a Poisson distribution, with a mean of:
$$𝔼 ( {N}_{N e w , H} ) = \frac{{λ}_{B}}{{λ}_{D}} [ 1 - {P}_{H , r e m a i n} ( {δ}_{H}^{T} ) ]$$
Step S2013: generating a visibility matrix of the LED cells in each column for the clusters based on the first-column LED cells L₁₁-L_{M}_{_{I}}₁ generated in Step S2012, wherein column evolution is performed in the vertical direction, and a survival probability of the clusters in a spacing of δ_{V}^{T} is:
$${P}_{V , remain} ( {δ}_{V}^{T} ) = exp ( - {λ}_{B} \cdot \frac{{δ}_{V}^{T} cos ( {β}_{V E}^{T} )}{{D}_{c}^{A}} )$$
the number of the newly generated clusters follows a Poisson distribution, with a mean of:
$$𝔼 ( {N}_{N e w , V} ) = \frac{{λ}_{B}}{{λ}_{D}} 1 - {P}_{V , remain} ( {δ}_{V}^{T} )$$
Step S2014: generating a final object reflection cluster birth-death process matrix of a transmitting-end array, namely, a matrix with dimensions of M_{I}×M_{J}×N_{c,total}, wherein the total number N_{c,total} of the object reflection clusters is equal to the sum of N_{c0} and the number of the newly generated clusters; and
Step S202: calculating an existence probability p_{LoS}=(1−p_{blockage})·(1−p_{particle}) of a direct component, and generating a 0/1 random number matrix for controlling whether the direct component exists according to the existence probability of the direct component, with dimensions of M_{I}×M_{J}; and generating Mₙ 0/1 random numbers according to p_{particle}, and classifying a propagation component according to whether the propagation component after object reflection further undergoes scattering before reaching the receiver, wherein Mₙ is the number of scatterers in the object reflection cluster.

5. The method according to claim 1, wherein the steps S3 further comprises:
Step S301: stochastically generating a position of the object reflection cluster at the initial moment, the initial position of the cluster determined by azimuth angle, elevation angle and distance parameters, specifically comprising:
Step S3011: stochastically generating the angle parameters of N_{c,total} object reflection clusters, modeling the same to follow a wrapped Gaussian distribution, and generating the angle parameters of N_{c,total}×(1−η_{SB}) object reflection clusters at the receiver; and
Step S3012: stochastically generating distances dₙ^{T}, and dₙ^{R} from the object reflection cluster to the LED unit L₁₁ at the initial moment, wherein a non-negative exponential distribution is followed;
Step S302: calculating an equivalent normal direction and an equivalent mirror reflection direction of each object reflection cluster according to a geometric relationship, wherein, in the case of single object reflection, an equivalent normal points from the cluster center to a ray from L₁₁ to the receiver, and is perpendicular to the ray, an equivalent mirror reflection direction vector is in the same plane as the cluster center, L₁₁ and the receiver, and an angle formed with the equivalent normal is equal to an angle between a vector from the cluster center to L₁₁ and the equivalent normal; and in the case of double object reflection, an equivalent normal of a transmitting-end cluster points from the cluster center to a ray from L₁₁ to a receiving-end cluster and is perpendicular to the ray, an equivalent mirror reflection direction vector thereof is in the same plane as the cluster center, L₁₁ and the receiving-end cluster, and an angle formed with the equivalent normal is equal to an angle between a vector from the cluster center to L₁₁ and the equivalent normal, an equivalent normal of the receiving-end cluster points from the cluster center to a ray from the transmitting-end cluster to the receiver and is perpendicular to the ray, an equivalent mirror reflection direction vector thereof is in the same plane as the cluster center, the transmitting-end cluster and receiver, and an angle formed with the equivalent normal is equal to an angle between a vector from the cluster center to the transmitting-end cluster and the equivalent normal;
Step S303: generating a particle scattering cluster representing a particle scattering effect of an ultraviolet light signal at the receiver, wherein a ray from the receiver to the center of the particle scattering cluster is kept consistent with the normal direction of the receiver in azimuth angle and elevation angle, and a distance from the center of the particle scattering cluster to the receiver is set to a constant; and
Step S304: stochastically generating the coordinates of each intra-cluster scatterer in the global coordinate system, specifically comprising:
Step S3041: stochastically generating the coordinates [x′, y′, z′]^{T} of each intra-cluster scatterer in a local coordinate system with the cluster center as the origin, following a three-dimensional elliptical Gaussian distribution, expressed as:
$$p ( {x}^{′} , {y}^{′} , {z}^{′} ) = \frac{exp ( - \frac{{x}^{′2}}{2 {σ}_{DS}^{2}} - \frac{{y}^{′2}}{2 {σ}_{A S}^{2}} - \frac{{z}^{′2}}{2 {σ}_{B S}^{2}} )}{{( 2 π )}^{\frac{3}{2}} {σ}_{D S} {σ}_{A S} {σ}_{E S}}$$
where, σ_{DS} and σ_{AS}, σ_{ES} represent intra-cluster delay spread, angular spread and elevation spread respectively, and different cluster spread parameters are substituted for the generation of the object reflection cluster and the particle scattering cluster; and
Step S3042: obtaining the coordinates [x, y, z]^{T} of each scatterer in the global coordinate system through coordinate transformation, expressed as:
$$[ \begin{matrix}x \\ y \\ z\end{matrix} ] = [ \begin{matrix}cos ( {\overline{ϕ}}_{A} ) & - sin ( {\overline{ϕ}}_{A} ) & 0 \\ sin ( {\overline{ϕ}}_{A} ) & cos ( {\overline{ϕ}}_{A} ) & 0 \\ 0 & 0 & 1\end{matrix} ] [ \begin{matrix}cos ( {\overline{ϕ}}_{E} ) & 0 & - sin ( {\overline{ϕ}}_{E} ) \\ 0 & 1 & 0 \\ sin ( {\overline{ϕ}}_{E} ) & 0 & cos ( {\overline{ϕ}}_{E} )\end{matrix} ] [ \begin{matrix}{x}^{′} + \overline{d} \\ {y}^{′} \\ {z}^{′}\end{matrix} ]$$
where, d̅, ϕ̅_{A} and ϕ̅_{E} represent an average distance, an azimuth angle and an elevation angle of a cluster respectively.

6. The method according to claim 5, wherein the step S4 further comprises:
Step S401: updating the coordinates of the scatterers and the receiver in the global coordinate system at each moment, and calculating the coordinates of Lᵢⱼ in the global coordinate system according to a geometric relationship and the set movement velocity of the object reflection cluster, and the movement and rotation velocity of the receiver;
Step S402: updating and calculating the angle parameters of each propagation ray in the local coordinate system of each LED cell, specifically comprising:
Step S4021: establishing a local coordinate system of an LED cell Lᵢⱼ, with the cell Lᵢⱼ in the ith row and jth column of the LED array as an origin, the normal direction of the LED array as an x′ᵢⱼ axis, the vertical direction of the LED array as a y′ᵢⱼ axis, and the horizontal direction of the LED array as a z′ᵢⱼ axis; and
Step S4022: performing a rotation transformation first on the Cartesian coordinates of each scatterer in the global coordinate system obtained in Step S3042 to obtain the Cartesian coordinates of the local coordinate system of the LED cell L₁₁, then, performing a translation transformation to obtain the Cartesian coordinates of the local coordinate system of the LED cell Lᵢⱼ, and at last, transforming the Cartesian coordinates of the local coordinate system of the LED cell Lᵢⱼ into spherical coordinates, to obtain an elevation angle of departure and an azimuth angle of departure of each propagation ray in the local coordinate system of the LED cell Lᵢⱼ, comprising an elevation angle of departure \tilde{ψ}_{ij,E,L}^{T}(t) and an azimuth angle of departure \tilde{ψ}_{ij,A,L}^{T}(t) of a direct path in the Lᵢⱼ local coordinate system, an elevation angle of departure \tilde{ψ}_{ij,E,q}^{T}(t) and an azimuth angle of departure \tilde{ψ}_{ij,A,q}^{T}(t) of a ray from Lᵢⱼ to the qth scatterer in the particle scattering cluster in the Lᵢⱼ local coordinate system, and an elevation angle of departure \tilde{ψ}_{ij,E,m}_{₁₍₂₎ₙ}^{T}(t) and an azimuth angle of departure \tilde{ψ}_{ij,A,m}_{₁₍₂₎ₙ}^{T}(t) of a ray from Lᵢⱼ to the m₁ (m₂)th scatterer in the nth object reflection cluster at the transmitter in the Lᵢⱼ local coordinate system;
Step S403: updating and calculating the angle parameters of each propagation ray according to the global coordinates of each scatterer and the receiver updated in Step S401, specifically comprising:
Step S4031: determining whether a ray in a single object reflection cluster reaches the receiver simply by a single reflection according to the 0/1 random numbers for propagation component classification generated in Step S202;
Step S4032: obtaining normalized transmission vectors according to a coordinate method, comprising a normalized direction vector r_{ij,L}^{T}(t) from Lᵢⱼ to the receiver, a normalized direction vector r_{ij,q}^{T}(t) from Lᵢⱼ to the qth scatterer in the particle scattering cluster, a normalized direction vector r_{q}^{R}(t) from the qth scatterer in the particle scattering cluster to the receiver, a normalized direction vector r_{ij,m}_{₁₍₂₎ₙ}^{T}(t) from Lᵢⱼ to the m₁ (m₂)th scatterer in the nth object reflection cluster at the transmitter, a normalized direction vector rₘ_{₁₍₂₎ₙ}^{R}(t) from the m₁ (m₂)th scatterer in the nth object reflection cluster at the transmitter to the receiver, a normalized direction vector rₘ_{₁ₙ}^{RE-RE}(t) from the m₁th scatterer in the nth object reflection cluster at the transmitter to the m₁th scatterer in the nth object reflection cluster at the receiver, and a normalized direction vector rₘ_{_{2n,q}}^{RE-PS}(t) from the m₂th scatterer in the nth object reflection cluster at the transmitter to the qth scatterer in the particle scattering cluster; and
Step S4033: updating and calculating the angle parameters of each propagation component according to the cosine law, comprising an angle ψ_{ij,L}^{R}(t) between −r_{ij,L}^{T}(t) and the normal direction of the receiver, an angle θ_{ij,q}^{PS}(t) between r_{ij,q}^{T}(t) and r_{q}^{R}(t), an angle ψ_{q}^{R}(t) between −r_{q}^{R}(t) and the normal direction of the receiver, an angle ψ_{ij,m}_{₁₍₂₎ₙ}^{S,T}(t) between −r_{ij,m}_{₁₍₂₎ₙ}^{T}(t) and the equivalent normal direction of the nth object reflection cluster at the transmitter, angles ψₘ_{₁ₙ}^{S,R,1}(t) and ψₘ_{₁ₙ}^{S,R,2}(t) between rₘ_{₁ₙ}^{R}(t) and the equivalent normal direction and equivalent mirror reflection direction of the nth object reflection cluster at the transmitter, an angle ψₘ_{₁ₙ}^{R}(t) between −rₘ_{₁ₙ}^{R}(t) and the normal direction of the receiver, angles ψₘ_{_{2n,q}}^{S,R,1}(t) and ψₘ_{_{2n,q}}^{S,R,2}(t) between rₘ_{_{2n,q}}^{RE-PS}(t) and the equivalent normal direction and equivalent mirror reflection direction of the nth object reflection cluster at the transmitter, and an angle θₘ_{_{2n,q}}^{PS}(t) between rₘ_{_{2n,q}}^{RE-PS}(t) and r_{q}^{R}(t); and
Step S404: updating and calculating the propagation distance parameters of each propagation ray at each moment according to the global coordinates of the scatterers, Lᵢⱼ and the receiver updated in Step S401 and a coordinate method, comprising a distance Dᵢⱼ(t) from Lᵢⱼ to the receiver, a distance d_{ij,q}^{T}(t) from Lᵢⱼ to the qth scatterer in the particle scattering cluster, a distance d_{q}^{R}(t) from the qth scatterer in the particle scattering cluster to the receiver, a distance d_{ij,m}_{₁₍₂₎ₙ}^{T}(t) from Lᵢⱼ to the m₁ (m₂)th scatterer in the nth object reflection cluster at the transmitter, a distance dₘ_{₁₍₂₎ₙ}^{R}(t) from the m₁ (m₂)th scatterer in the nth object reflection cluster at the transmitter to the receiver, a distance dₘ_{₁ₙ}^{RE-RE}(t) from the m₁th scatterer in the nth object reflection cluster at the transmitter to the m₁th scatterer in the n object reflection cluster at the receiver, and a distance dₘ_{_{2n,q}}^{RE-PS}(t) from the m₂th scatterer in the nth object reflection cluster at the transmitter to the qth scatterer in the particle scattering cluster.

7. The method according to claim 6, wherein the step S5 further comprises:
Step S501: calculating a light source radiation intensity in a direction corresponding to the propagation ray, expressed as:
$${F}_{i j} ( {\tilde{ψ}}_{ij , E}^{T} , {\tilde{ψ}}_{ij , A}^{T} ) = \frac{α + 1}{2 π} {cos}^{α} ( {\tilde{ψ}}_{ij , E}^{T} ) {cos}^{α} ( {\tilde{ψ}}_{ij , A}^{T} )$$
where, α is a mode number of a Lambertian radiation mode; and the angle parameters obtained in Step S4022 are substituted in the equation above to calculate a light source radiation intensity corresponding to each propagation component;
Step S502: calculating a power distribution of the propagation ray after object reflection according to a Phong's reflection model, expressed as:
$${R}_{n} ( {ψ}_{n}^{S , R , 1} ( t ) , {ψ}_{n}^{S , R , 2} ( t ) ) = {α}_{n} \frac{cos ( {ψ}_{n}^{S , R , 1} ( t ) )}{π} + ( 1 - {α}_{n} ) \frac{{m}_{s n} + 1}{2 π} {cos}^{{m}_{s n}} ( {ψ}_{n}^{S , R , 2} ( t ) )$$
where, mₛₙ is a directional parameter of a mirror reflection component; and the angle parameters between the propagation ray and the equivalent normal direction and equivalent mirror reflection direction of the object reflection cluster obtained in Step S4033 are substituted in the equation above, to calculate the radiation powers of the propagation components after object reflection within a unit solid angle in the propagation direction;
Step S503: calculating a power distribution of the propagation ray after particle scattering according to a particle scattering phase function, expressed as:
$$P ( {θ}^{P S} ) = \frac{{k}_{s , r}}{{k}_{s}} {P}_{r} ( {θ}^{P S} ) + \frac{{k}_{s , m}}{{k}_{s}} {P}_{m} ( {θ}^{P S} )$$
where, kₛ is a scattering coefficient, equal to the sum of a particle Rayleigh scattering coefficient kₛᵣ and a particle Mie scattering coefficient kₛₘ, and Pᵣ(θ^{PS}) and Pₘ(θ^{PS}) are a Rayleigh scattering phase function and a Mie scattering phase function respectively, wherein Pᵣ(θ^{PS}) is expressed as:
$${P}_{r} ( {θ}^{P S} ) = \frac{3 [ 1 + 3 γ + ( 1 - γ ) {cos}^{2} {θ}^{P S} ]}{16 π ( 1 + 2 γ )}$$
where, γ is a Rayleigh scattering model parameter, determined by a depolarization factor;
Pₘ(θ^{PS}) is expressed as:
$${P}_{m} ( {θ}^{P S} ) = \frac{1 - {g}^{2}}{4 π} [ \frac{1}{{( 1 + {g}^{2} - 2 g cos {θ}^{P S} )}^{3 / 2}} + \frac{f ( 3 {cos}^{2} {θ}^{P S} - 1 )}{2 {( 1 + {g}^{2} )}^{3 / 2}} ]$$
where, g and f are light wavelength-related Mie scattering model parameters; and the angle parameters θ_{ij,q}^{PS}(t) and θₘ_{₂ₙ}_{,q}^{PS}(t) obtained in Step $4033 are substituted in the expression of the particle scattering phase function, to obtain the radiation powers of the propagation components after particle scattering within a unit solid angle in the propagation direction respectively; and
Step S504: calculating a wavelength range-related equivalent reflection coefficient, expressed as:
$${Γ}_{ij , {λ}_{T} , n} = {\int }_{{λ}_{1}}^{{λ}_{2}} {Φ}_{i j} ( λ ) {ρ}_{n} ( λ ) d λ$$
where, Φᵢⱼ(λ) is a radiation power spectrum density of the LED cell Lᵢⱼ, varying with wavelength, ρₙ(λ) is a reflectivity of the nth object reflection cluster, varying with wavelength, and [λ₁, λ₂] is a wavelength range of the color of the light emitted by an LED lamp.

8. The method according to claim 7, wherein the step S6 further comprises:
Step S601: calculating a channel impulse response of a direct propagation component, specifically comprising:
Step S6011: calculating a ray power of a direct propagation component, expressed as:
$${P}_{i j}^{L} ( t ) = {F}_{i j} ( {\tilde{ψ}}_{ij , E , L}^{T} ( t ) , {\tilde{ψ}}_{ij , A , L}^{T} ( t ) ) \cdot \frac{{A}_{R} cos ( {ψ}_{i j , L}^{R} ( t ) )}{{( {D}_{i j} ( t ) )}^{2}} \cdot G ( {ψ}_{i j , L}^{R} ( t ) ) T ( {ψ}_{i j , L}^{R} ( t ) ) V ( {ψ}_{i j , L}^{R} ( t ) ) \cdot exp ( - {k}_{e} {D}_{i j} ( t ) )$$
where, at the frequency bands of infrared light and visible light in an indoor scenario, if kₑ=0, the model is reduced to a model supporting infrared light and visible light, and a particle extinction attenuation is 1;
Step S6012: calculating a propagation delay of a direct propagation component, expressed as:
$${τ}_{i j}^{L} ( t ) = {D}_{i j} ( t ) / {c}_{l}$$
where, cₗ is the speed of light; and
Step S6013: generating a channel impulse response of a direct component in each subchannel according to the parameters calculated in Step S6011 and Step S6012, expressed as:
$${h}_{i j}^{L} ( t , τ ) = {P}_{i j}^{L} ( t ) \cdot δ ( τ - {τ}_{i j}^{L} ( t ) )$$
Step S602: calculating a channel impulse response of an indirect propagation component, specifically comprising:
Step S6021: calculating a ray power of a propagation component that is emitted from Lᵢⱼ and reaches the receiver simply through particle scattering, expressed as:
$${P}_{ij , q}^{N} ( t ) = {F}_{i j} ( {\tilde{ψ}}_{ij , E , q}^{T} ( t ) , {\tilde{ψ}}_{ij , A , q}^{T} ( t ) ) \times \frac{{k}_{s} exp ( - {k}_{e} {d}_{i j , q}^{T} ( t ) )}{{( {d}_{i j , q}^{T} ( t ) )}^{2}} \cdot {V}_{q , eff} \times P ( {θ}_{i j , q}^{P S} ( t ) ) exp ( - {k}_{e} {d}_{q}^{R} ( t ) ) \frac{{A}_{R} cos ( {ψ}_{q}^{R} ( t ) )}{{( {d}_{q}^{R} ( t ) )}^{2}} \times G ( {ψ}_{q}^{R} ( t ) ) T ( {ψ}_{q}^{R} ( t ) ) V ( {ψ}_{q}^{R} ( t ) )$$
where, V_{q,eff} is an equivalent volume of each scatterer in the particle scattering cluster, related to an equivalent volume V_{c,eff} of the particle scattering cluster, and calculated as V_{q,eff}=V_{c,eff}/Q^{PS}, and Q^{PS} is the number of scatterers in the particle scattering cluster; and G(ψ^{R}) and T(ψ^{R}) are an optical focusing lens gain and an optical filter gain respectively, V(ψ^{R}) is a viewshed function, and V(ψ^{R}) is expressed as:
$$V ( {ψ}^{R} ) = \{ \begin{matrix}1 , & 0 \leq {ψ}^{r} \leq {Ψ}_{FoV} \\ 0 , & {ψ}^{R} > {Ψ}_{FoV}\end{matrix}$$
Step S6022: calculating a ray delay of a propagation component that is emitted from Lᵢⱼ and reaches the receiver simply through particle scattering, expressed as:
$${τ}_{ij , q}^{N} ( i ) = ( {d}_{i j , q}^{T} ( t ) + {d}_{q}^{R} ( t ) ) / {c}_{l}$$
Step S6023: calculating a ray power of a propagation component that is emitted from Lᵢⱼ and reaches the receiver simply through object reflection, in the case of single reflection, expressed as:
$${P}_{ij , {m}_{1 n}}^{N} ( t ) = {F}_{i j} ( {\tilde{ψ}}_{ij , E , {m}_{1 n}}^{T} ( t ) , {\tilde{ψ}}_{ij , A , {m}_{1 n}}^{T} ( t ) ) \times \frac{{A}_{s , e f f} cos ( {ψ}_{ij , {m}_{1 n}}^{S , T} ( t ) )}{{( {d}_{i j , {m}_{1 n}}^{T} ( t ) )}^{2}} \times {Γ}_{ij , {λ}_{T} , n} {R}_{n} ( {ψ}_{{m}_{1 n}}^{S , R , 1} ( t ) , {ψ}_{{m}_{1 n}}^{S , R , 2} ( t ) ) \frac{{A}_{R} cos ( {ψ}_{{m}_{1 n}}^{R} ( t ) )}{{( {d}_{{m}_{1 n}}^{R} ( t ) )}^{2}} \times G ( {ψ}_{{m}_{1 n}}^{R} ( t ) ) T ( {ψ}_{{m}_{1 n}}^{R} ( t ) ) V ( {ψ}_{{m}_{1 n}}^{R} ( t ) ) \times exp [ - {k}_{e} ( {d}_{i j , {m}_{1 n}}^{T} ( t ) + {d}_{{m}_{1 n}}^{R} ( t ) ) ]$$
wherein, in the case of double object reflection, a channel is characterized by two clusters located at the transmitter and the receiver respectively; and compared with the single reflection, the calculation of the ray power adds a power loss from a transmitting-end scatterer to a receiving-end scatterer;
Step S6024: calculating a ray power of a propagation component that is emitted from Lᵢⱼ and reaches the receiver simply through object reflection, in the case of single reflection, expressed as:
$${τ}_{ij , {m}_{1 n}}^{N} ( t ) = ( {d}_{i j , {m}_{1 n}}^{T} ( t ) + {d}_{{m}_{1 n}}^{R} ( t ) ) / {c}_{l}$$
in the case of double reflection, expressed as:
$${τ}_{ij , {m}_{1 n}}^{N} ( t ) = ( {d}_{i j , {m}_{1 n}}^{T} ( t ) + {d}_{{m}_{1 n}}^{R E - R E} ( t ) + {d}_{{m}_{1 n}}^{R} ( t ) ) / {c}_{l}$$
Step S6025: calculating a ray power of a propagation component that is emitted from Lᵢⱼ and undergoes object reflection and then particle scattering, expressed as:
$${P}_{ij , {m}_{2 n} , q}^{N} ( t ) = {F}_{i j} ( {\tilde{ψ}}_{ij , E , {m}_{2 n}}^{T} ( t ) ) , {\tilde{ψ}}_{ij , A , {m}_{2 n}}^{T} ( t ) ) exp ( - {k}_{e} {d}_{i j , {m}_{2 n}}^{T} ( t ) ) \times \frac{{A}_{s , e f f} cos ( {ψ}_{ij , {m}_{2 n}}^{S , T} ( t ) )}{{( {d}_{i j , {m}_{2 n}}^{T} ( t ) )}^{2}} \times {Γ}_{ij , {λ}_{T} , n} {R}_{n} ( {ψ}_{{m}_{2 n} , q}^{S , R , 1} ( t ) , {ψ}_{{m}_{2 n} , q}^{S , R , 1} ( t ) ) \times \frac{{k}_{s} exp ( - {k}_{e} {d}_{{m}_{2 n} , q}^{R E - P S} ( t ) )}{{( {d}_{{m}_{2 n} , q}^{R E - P S} ( t ) )}^{2}} \cdot {V}_{q , eff} \times P ( {θ}_{{m}_{2 n} , q}^{P S} ( t ) ) exp ( - {k}_{e} {d}_{q}^{R} ( t ) ) \frac{{A}_{R} cos ( {ψ}_{q}^{R} ( t ) )}{{( {d}_{q}^{R} ( t ) )}^{2}} \times G ( {ψ}_{q}^{R} ( t ) ) T ( {ψ}_{q}^{R} ( t ) ) V ( {ψ}_{q}^{R} ( t ) )$$
wherein a signal passes through random Mₙ·p_{particle} scatterers in each object reflection cluster before particle scattering, and it is determined whether a ray in the object reflection cluster undergoes single object reflection and then particle scattering before reaching the receiver according to the 0/1 random numbers for propagation component classification generated in Step S202;
Step S6026: calculating a propagation delay of a propagation component that is emitted from Lᵢⱼ and undergoes object reflection and then particle scattering, expressed as:
$${τ}_{i j , {m}_{2 n} , q}^{N} ( t ) = ( {d}_{i j , {m}_{2 n}}^{T} ( t ) + {d}_{{m}_{2 n} , q}^{R E - P S} ( t ) + {d}_{q}^{R} ( t ) ) / {c}_{l}$$
Step S6027: generating a channel impulse response of a direct component in each subchannel according to the parameters calculated in Step S6021 and Step S6026, expressed as:
$${h}_{i j}^{N} ( t , τ ) = ⌈ {p}_{p a r t i c l e} ⌉ \cdot {\sum }_{q = 1}^{{Q}^{P S}} {P}_{i j , q}^{N} ( t ) \cdot δ ( τ - {τ}_{ij , q}^{N} ( t ) ) + {\sum }_{n = 1}^{{N}_{ij} ( t )} {\sum }_{{m}_{1} = 1}^{{M}_{n} \cdot ( 1 - {p}_{particle} )} {P}_{ij , {m}_{1 n}}^{N} ( t ) \cdot δ ( τ - {τ}_{ij , {m}_{1 n}}^{N} ( t ) ) + {\sum }_{n = 1}^{{N}_{ij} ( t )} {\sum }_{{m}_{1} = 1}^{{M}_{n} \cdot {p}_{particle}} {P}_{ij , {m}_{2 n} , q}^{N} ( t ) \cdot δ ( τ - {τ}_{ij , {m}_{2 n} , q}^{N} ( t ) )$$
where, Nᵢⱼ(t) denotes the number of clusters of a subchannel from the LED cell Lᵢⱼ to the receiver at a moment t; and at the frequency bands of infrared light and visible light in an indoor scenario, if p_{particle}=0 and kₑ=0, the model is reduced to a model supporting infrared light and visible light, only an indirect component that reaches the receiver through object reflection exists, and the particle extinction attenuation of the indirect component calculated in Step S6023 is 1;
Step S603: determining whether an indirect component corresponding to the object reflection cluster exists according to the birth-death matrix generated in Step S201, and setting a contribution of an invisible link to the channel impulse response to zero; and
Step S604: determining whether a direct component exists in each subchannel according to the random number matrix for controlling whether a direct component exists generated in Step S202, to obtain a final channel impulse response.
